(19) United States
(12) Patent Application Publication
(10) Pub. No.: US 2024/0341013 A1
(43) Pub. Date: Oct. 10, 2024

(54) ELECTRONIC APPARATUS CONTROLLING TARGET OUTPUT ACCORDING TO INPUT POWER OF POWER SUPPLY CIRCUIT AND CONTROLLING METHOD THEREOF

(71) Applicant: Samsung Electronics Co., Ltd., Suwon-si (KR)

(72) Inventors: Dongwook KIM, Suwon-si (KR); Jaehee SHIN, Suwon-si (KR); Hongjoo KANG, Suwon-si (KR); Jiwoong CHOI, Suwon-si (KR); Kumchul HWANG, Suwon-si (KR)

(21) Appl. No.: 18/733,336

(22) Filed: Jun. 4, 2024

Related U.S. Application Data
(63) Continuation of application No. PCT/KR2024/004525, filed on Apr. 5, 2024.

(30) Foreign Application Priority Data
Apr. 5, 2023 (KR) 10-2023-0044924
Jul. 11, 2023 (KR) 10-2023-0090056

(51) Int. Cl. H05B 6/06; H05B 6/12

(52) U.S. Cl. CPC H05B 6/062; H05B 6/1209

(57) ABSTRACT

An electronic apparatus is provided. The electronic apparatus includes a user interface, a cooking plate on which a cooking vessel can be placed, an induction heating coil configured to induce a magnetic field on the cooking plate, a power supply circuit configured to supply power to the induction heating coil, memory storing one or more computer programs, and one or more processors communicatively coupled to the user interface, the cooking plate, the induction heating coil, and the power supply circuit, wherein the one or more computer programs include computer-executable instructions that, when executed by the one or more processors cause the electronic apparatus to control the power supply circuit based on a first target power for heating the cooking vessel, and control the power supply circuit based on a second target power corresponding to the first input power of the power supply circuit.

### CROSS-REFERENCE TO RELATED APPLICATION(S)

This application is a continuation application, claiming priority under § 365(c), of an International application No. PCT/KR2024/004525, filed on Apr. 5, 2024, which is based on and claims the benefit of a Korean patent application number 10-2023-0044924, filed on Apr. 5, 2023, in the Korean Intellectual Property Office, and of a Korean patent application number 10-2023-0090056, filed on Jul. 11, 2023, the disclosure of each of which is incorporated by reference herein in its entirety.

### TECHNICAL FIELD

The disclosure relates to an electronic apparatus and a method of controlling thereof. More particularly, the disclosure relates to an electronic apparatus that controls target power according to input power of a power supply circuit and a method of controlling thereof.

### BACKGROUND ART

An induction heating device may be a cooking device which heats and cooks food using a principle of induction heating. The induction heating device may include a cooking plate on which cooking vessels are placed, a power supply circuit that applies current to coils, and coils that generate a magnetic field when current is applied.

When a magnetic field is generated due to current being applied to the coils, a secondary current is induced to the cooking vessel, and joule heat may be generated by a resistance component of the cooking vessel itself.

Accordingly, the cooking vessel may be heated by the current induced to the cooking vessel and the food contained in the cooking vessel may be cooked. Because the cooking vessel itself acts as a heat generating source in an induction heating system, iron or stainless steel, nickel, and the like, which are metallic, may be used as material for the cooking vessel.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an electronic apparatus controlling target output according to input power of power supply circuit and method of controlling thereof.

Additional aspects will be set forth in part in the description which follows and, in part, will be apparent from the description, or may be learned by practice of the presented embodiments.

In accordance with an aspect of the disclosure, an electronic apparatus is provided. The electronic apparatus includes a user interface, a cooking plate on which a cooking vessel can be placed, an induction heating coil configured to induce a magnetic field on the cooking plate, a power supply circuit configured to supply power to the induction heating coil, memory storing one or more computer programs, and one or more processors communicatively coupled to the user interface, the cooking plate, the induction heating coil, and the power supply circuit, wherein the one or more computer programs include computer-executable instructions that, when executed by the one or more processors cause the electronic apparatus to control the power supply circuit based on a first target power corresponding to an operation step input by a user through the user interface, and control, based on a difference between a first input power of the power supply circuit and the first target power being greater than or equal to a predetermined value, the power supply circuit based on a second target power corresponding to the first input power of the power supply circuit.

In accordance with another aspect of the disclosure, a method of controlling an electronic apparatus is provided. The method includes controlling a power supply circuit based on a first target power corresponding to an operation step input by a user, and controlling, based on a difference between a first input power of the power supply circuit and the first target power being greater than or equal to a predetermined value, the power supply circuit based on a second target power corresponding to the first input power of the power supply circuit.

In accordance with another aspect of the disclosure, one or more non-transitory computer readable storage media storing computer-executable instructions that, when executed by one or more processors of an electronic apparatus, cause the electronic apparatus to perform operations are provided. The operations include controlling a power supply circuit based on a first target power corresponding to an operation step input by a user, and controlling, based on a difference between a first input power of the power supply circuit and the first target power being greater than or equal to a predetermined value, the power supply circuit based on a second target power corresponding to the first input power of the power supply circuit.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating a configuration of an electronic apparatus according to an embodiment of the disclosure;

FIG. 2 is a diagram illustrating an exterior of an electronic apparatus according to an embodiment of the disclosure;

FIG. 3 is a diagram illustrating an inner part of an electronic apparatus according to an embodiment of the disclosure;

FIGS. 4A and 4B are diagrams illustrating a power supply circuit according to various embodiments of the disclosure;

FIG. 5 is a flowchart illustrating a method by which an electronic apparatus controls input power of a power supply circuit 150 according to an embodiment of the disclosure;

FIGS. 6A, 6B, and 6C are diagrams illustrating information stored in memory according to various embodiments of the disclosure;

FIGS. 7A, 7B, 7C, 7D, 7E, and 7F are flowcharts illustrating a method by which an electronic apparatus controls a power supply circuit based on whether a predetermined condition is satisfied according to various embodiments of the disclosure;

FIG. 8 is a diagram illustrating a method by which an electronic apparatus controls input power according to an embodiment of the disclosure;

FIGS. 9, 10A, and 10B are diagrams illustrating a method by which an electronic apparatus readjusts target power according to temperature of a power supply circuit according to various embodiments of the disclosure;

FIG. 11 is a flowchart illustrating a method by which an electronic apparatus re-adjusts target power according to an embodiment of the disclosure;

FIG. 12 is a flowchart illustrating a method by which an electronic apparatus provides information notifying that target power or an operation step has been adjusted according to an embodiment of the disclosure;

FIGS. 13A and 13B are diagrams illustrating a method by which an electronic apparatus provides information notifying that target power or an operation step of a power supply circuit has been adjusted according to various embodiments of the disclosure;

FIGS. 14 and 15 are diagrams illustrating a method by which an electronic apparatus operates when a user input for re-adjusting an operation step (or target power) is obtained according to various embodiments of the disclosure; and

FIG. 16 is a flowchart illustrating a method of controlling an electronic apparatus according to an embodiment of the disclosure.

The same reference numerals are used to represent the same elements throughout the drawings.

### DETAILED DESCRIPTION OF EXEMPLARY EMBODIMENTS

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, description of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure, expressions, such as “have,” “may have,” “include,” “may include,” or the like are used to designate a presence of a corresponding characteristic (e.g., elements, such as numerical value, function, operation, or component), and not to preclude a presence or a possibility of additional characteristics.

In the disclosure, expressions, such as “A or B,” “at least one of A and/or B,” or “one or more of A and/or B” may include all possible combinations of the items listed together. For example, “A or B,” “at least one of A and B,” or “at least one of A or B” may refer to all cases including (1) at least one A, (2) at least one B, or (3) both of at least one A and at least one B.

Expressions, such as “first,” “second,” “1st,” “2nd,” and so on used herein may be used to refer to various elements regardless of order and/or importance. Further, it should be noted that the expressions are merely used to distinguish an element from another element and not to limit the relevant elements.

When a certain element (e.g., first element) is indicated as being “(operatively or communicatively) coupled with/to” or “connected to” another element (e.g., second element), it may be understood as the certain element being directly coupled with/to the another element or as being coupled through other element (e.g., third element).

On the other hand, when a certain element (e.g., first element) is indicated as “directly coupled with/to” or “directly connected to” another element (e.g., second element), it may be understood as the other element (e.g., third element) not being present between the certain element and the another element.

The expression “configured to . . . (or set up to)” used in the disclosure may be used interchangeably with, for example, “suitable for . . . ,” “having the capacity to . . . ,” “designed to . . . ,” “adapted to . . . ,” “made to . . . ,” or “capable of . . . ” based on circumstance. The term “configured to . . . (or set up to)” may not necessarily mean “specifically designed to” in terms of hardware.

Rather, in a certain circumstance, the expression “a device configured to . . . ” may mean something that the device “may perform . . . ” together with another device or components. For example, the phrase “a sub-processor configured to (or set up to) perform A, B, or C” may mean a dedicated processor for performing a corresponding operation (e.g., embedded processor), or a generic-purpose processor (e.g., a central processing unit (CPU) or an application processor) capable of performing the corresponding operations by executing one or more software programs stored in the memory device.

The term ‘module’ or ‘part’ used in the embodiments herein perform at least one function or operation, and may be implemented with a hardware or software, or implemented with a combination of hardware and software. Further, a plurality of ‘modules’ or a plurality of ‘parts,’ except for a ‘module’ or a ‘part’ which needs to be implemented to a specific hardware, may be integrated to at least one module and implemented in at least one processor.

Meanwhile, the various elements and areas of the drawings have been schematically illustrated. Accordingly, the technical spirit of the disclosure is not limited by relative sizes and distances illustrated in the accompanied drawings.

Embodiments according the disclosure will be described with reference to the accompanying drawings to aid in the understanding of those of ordinary skill in the art.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

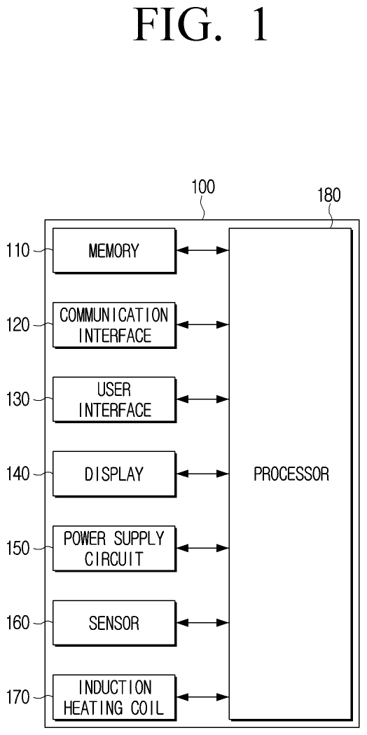

FIG. 1 is a block diagram illustrating a configuration of an electronic apparatus according to an embodiment of the disclosure.

Referring to FIG. 1, an electronic apparatus 100 may include memory 110, a communication interface 120, a user interface 130, a display 140, a power supply circuit 150, a sensor 160, an induction heating coil 170, and a processor 180. A portion from among the elements above may be omitted from the electronic apparatus 100. Further, the electronic apparatus 100 may further include other elements.

The electronic apparatus 100 may be a cooking device for heating a cooking material. For example, the electronic apparatus 100 may be implemented as an induction heating device, such as an induction, but is not limited thereto, and may be implemented as a cooking device of various forms.

Alternatively, the electronic apparatus 100 may be an apparatus for controlling a cooking device while performing communication with the cooking device. At this time, the electronic apparatus 100 may be implemented in various forms, such as, for example, and without limitation, a smartphone, a server, a television (TV), a smart TV, a set top box, a mobile phone, a personal digital assistant (PDA), a laptop, a media player, an e-book reader, a terminal for digital broadcast, a navigation, a kiosk, a moving picture experts group (MPEG) audio layer 3 (MP3) player, a wearable device, a home appliance and other mobile or non-mobile computing apparatus, and the like.

Alternatively, the electronic apparatus 100 may be a power supply device for supplying power to an external device. For example, the electronic apparatus 100 may be a wireless power supply device, such as a wireless charging device which charges the external device wirelessly, but is not limited thereto.

The memory 110 may store at least one instruction associated with the electronic apparatus 100. The memory 110 may store an operating system (O/S) for driving the electronic apparatus 100. In addition, the memory 110 may store various software programs or applications for the electronic apparatus 10 to operate according to various embodiments of the disclosure. Further, the memory 110 may include a semiconductor memory, such as flash memory, a magnetic storage medium, such as a hard disk, or the like.

Specifically, the memory 110 may store various software modules for the electronic apparatus 100 to operate according to the various embodiments of the disclosure, and the processor 180 may control an operation of the electronic apparatus 100 by executing various software modules stored in the memory 110. For example, the memory 110 may be accessed by the processor 180, and reading, writing, modifying, deleting, updating, and the like of data may be performed by the processor 180.

Meanwhile, the term memory 110 in the disclosure may be used as a meaning that includes the memory 110, read only memory (ROM, not shown) in the processor 180, random access memory (RAM; not shown), or memory card (not shown) mounted in the electronic apparatus 100 (e.g., micro secure digital (SD) card, memory stick).

Further, the communication interface 120 may include circuitry, and may be a configuration capable of communicating with an external device and a server. The communication interface 120 may perform communication with the external device or the server based on a wired or wireless communication method. The communication interface 120 may include a Bluetooth module (not shown), a Wi-Fi module (not shown), an infrared (IR) module, a local area network (LAN) module, an Ethernet module, and the like. Here, each communication module may be implemented in at least one hardware chip form. The wireless communication module may include at least one communication chip which performs communication according to various wireless communication standards, such as, for example, and without limitation, ZigBee, universal serial bus (USB), a mobile industry processor interface camera serial interface (MIPI CSI), 3^{rd} generation (3G), 3^{rd} generation partnership project (3GPP), long term evolution (LTE), LTE advanced (LTE-A), 4^{th} generation (4G), 5^{th} generation (5G), and the like in addition to the above-described communication methods. However, the above is merely one embodiment and the communication interface 120 may use at least one communication module from among the various communication modules.

The user interface 130 may be implemented with a device, such as a button, a touch pad, a mouse and a keyboard, or implemented also as a touch screen capable of performing a display function of a display 140 which will be described below and an operation input function together therewith. Here, the button may be a button of various types, such as a mechanical button, a touch pad, or a wheel which is formed at a random area at a front surface part or a side surface part, a rear surface part, or the like of an exterior of a main body of the electronic apparatus 100.

The display 140 may be implemented as a display of various types, such as, for example, and without limitation, a liquid crystal display (LCD), an organic light emitting diode (OLED) display, a plasma display panel (PDP), and the like. In the display 140, a driving circuit, which may be implemented in the form of an amorphous silicon thin film transistor (a-si TFT), a low temperature poly silicon (LTPS) TFT, an organic TFT (OTFT), or the like, a backlight unit, and the like may be included. Meanwhile, the display 140 may be implemented as a touch screen coupled with a touch sensor, a flexible display, a three-dimensional display (3D display), or the like. In addition, according to an embodiment of the disclosure, the display 140 may include not only a display panel that outputs an image, but also a bezel which houses the display panel. Specifically, according to an embodiment of the disclosure, the bezel may include a touch sensor (not shown) for sensing user interaction.

The power supply circuit 150 may be a device that converts power input to the power supply circuit 150, and supplies the converted power. The power supply circuit 150 may provide the converted power to the induction heating coil 170. The power supply circuit 150 may include an inverter for converting the input power. Further, the inverter may include a switching element for controlling power that is input in the power supply circuit 150. Specifically, the inverter may include a switching element for controlling a frequency of current (current frequency) constituting input power that is input in the power supply circuit 150.

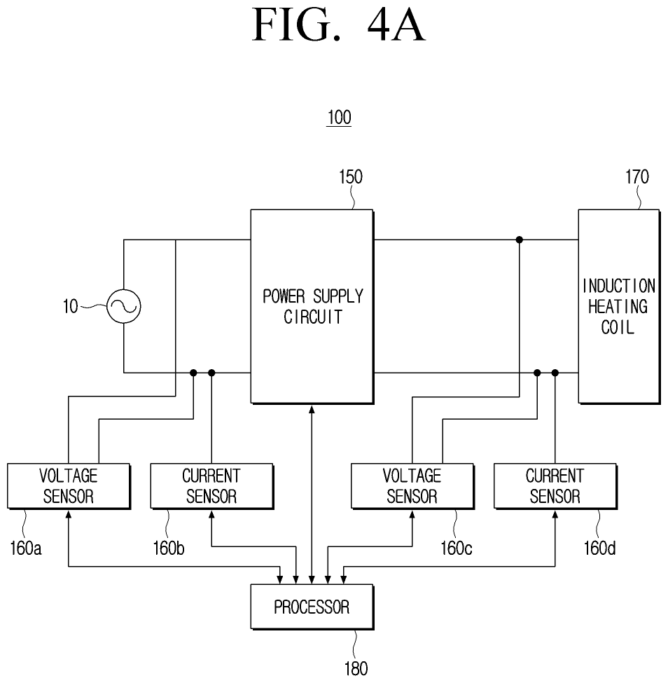

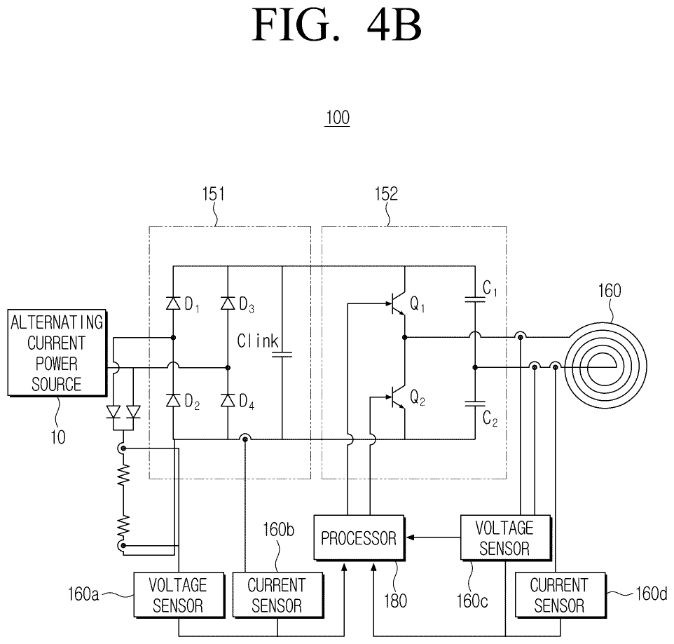

The power supply circuit 150 may include circuitry for converting the input power, and the circuitry for converting the input power will be described below with reference to FIGS. 4A and 4B.

The sensor 160 may include at least one sensor. Specifically, the sensor 160 may include at least one sensor for sensing the voltage or current. For example, the sensor 160 may include at least one voltage sensor for sensing voltage constituting the input power of the power supply circuit 150 or at least one current sensor for sensing current constituting the input power of the power supply circuit 150.

Alternatively, the sensor 160 may include at least one voltage sensor for sensing voltage constituting supply power which is supplied by the power supply circuit 150 to the induction heating coil 170 or at least one current sensor for sensing current constituting the supply power which is supplied by the power supply circuit 150 to the induction heating coil 170.

Alternatively, the sensor 160 may include at least one sensor for sensing temperature of a configuration included in the electronic apparatus 100. For example, the sensor 160 may include at least one temperature sensor for sensing a temperature of a device constituting the power supply circuit 150. For example, the sensor 160 may include a temperature sensor for sensing a temperature of a switching element constituting the power supply circuit 150.

Alternatively, the sensor 160 may include a sensor for sensing a cooking vessel placed on a cooking plate. For example, the sensor 160 may include at least on weight sensor for sensing the cooking vessel placed on the cooking plate. Alternatively, the sensor 160 may include at least one magnetic sensor for sensing the cooking vessel placed on the cooking plate on the cooking plate.

The induction heating coil 170 may induce a magnetic field for heating the cooking vessel. When power is supplied to the induction heating coil 170 by the power supply circuit 150, the magnetic field may be induced by an electromagnetic induction phenomenon.

The processor 180 may control the overall operation and functions of the electronic apparatus 100. Specifically, the processor 180 may control the overall operation of the electronic apparatus 100 by being connected with configurations of the electronic apparatus 100 including the memory 110, and by executing the at least one instruction stored in the memory 110 as described above.

The processor 180 may be implemented in various methods. For example, the processor 180 may be implemented as at least one from among an application specific integrated circuit (ASIC), a logic integrated circuit, an embedded processor, Micom, a microprocessor, a hardware control logic, a hardware finite state machine (FSM), and a digital signal processor (DSP). Meanwhile, the term processor 180 in the disclosure may be used as a meaning that includes a central processing unit (CPU), a graphic processing unit (GPU), an accelerated processing unit (APU), many integrated core (MIC), a digital signal processor (DSP), a neural processing unit (NPU), a main processing unit (MPU), and the like.

In particular, the processor 180 may include at least one processor. Specifically, the at least one processor may include at least one from among the CPU, the GPU, the APU, the MIC, the DSP, the NPU, the MPU, a hardware accelerator, or a machine learning accelerator. The at least one processor may control one or a random combination from among other elements of the electronic apparatus, and perform an operation associated with communication or data processing. The at least one processor may execute at least one program or instruction stored in the memory. For example, the at least one processor may perform, by executing at least one instruction stored in the memory, a method according to an embodiment of the disclosure.

When a method according to one or more embodiments of the disclosure includes a plurality of operations, the plurality of operations may be performed by one processor, or performed by a plurality of processors. For example, when a first operation, a second operation, and a third operation are performed by a method according to one or more embodiments of the disclosure, the first operation, the second operation, and the third operation may all be performed by a first processor, or the first operation and the second operation may be performed by the first processor (e.g., a generic-purpose processor) and the third operation may be performed by a second processor (e.g., an artificial intelligence dedicated processor).

The at least one processor may be implemented as a single core processor that includes one core, or as at least one multicore processor that includes a plurality of cores (e.g., a homogeneous multicore or a heterogeneous multicore). If the at least one processor is implemented as a multicore processor, the respective cores included in the multicore processor may include memory inside the processor, such as cache memory and an on-chip memory, and a common cache shared by the plurality of cores may be included in the multicore processor. In addition, the respective cores (or a portion from among the plurality of cores) included in the multicore processor may independently read and perform a program command for implementing a method according to one or more embodiments of the disclosure, or read and perform a program command for implementing a method according to one or more embodiments of the disclosure due to a whole (or a portion) of the plurality of cores being interconnected.

When a method according to one or more embodiments of the disclosure include a plurality of operations, the plurality of operations may be performed by one core from among the plurality of cores or performed by the plurality of cores included in the multicore processor. For example, when a first operation, a second operation, and a third operation are performed by a method according to one or more embodiments of the disclosure, the first operation, the second operation, and the third operation may all be performed by a first core included in the multicore processor, or the first operation and the second operation may be performed by the first core included in the multicore processor and the third operation may be performed by a second core included in the multicore processor.

In the embodiments of the disclosure, the processor 180 may refer to a system on chip (SoC), a single core processor, or a multicore processor in which the at least one processor and other electronic components are integrated or a core included in the single core processor or the multicore processor, and the core herein may be implemented as the CPU, the GPU, the APU, the MIC, the DSP, the NPU, the hardware accelerator, the machine learning accelerator, or the like, but is not limited to the embodiments of the disclosure.

An operation of the processor 180 for implementing the various embodiments of the disclosure may be implemented through a plurality of modules.

Specifically, data of the plurality of modules according to the disclosure may be stored in the memory 110, and the processor 180 may implement the various embodiments according to the disclosure by using the plurality of modules after accessing the memory 110 and loading the data of the plurality of modules in the memory inside the processor 180 or a buffer.

However, at least one from among the plurality of modules according to the disclosure may be implemented as hardware and included in the processor 180 in the form of a system on chip.

Alternatively, at least one from among the plurality of modules according to the disclosure may be implemented as a separate external device, and the electronic apparatus 100 and respective modules may perform an operation according to the disclosure while performing communication.

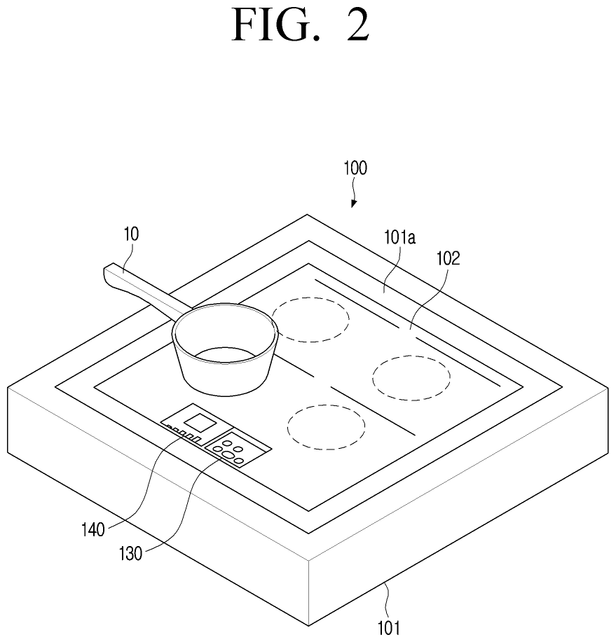

FIG. 2 is a diagram illustrating an exterior of an electronic apparatus according to an embodiment of the disclosure.

Referring to FIG. 2, the electronic apparatus 100 may include a main body 101 constituting an exterior of the electronic apparatus 100 and in which an element of the electronic apparatus 100 is installed

Further, at an upper surface 101a of the main body 101, a cooking plate 102 having a flat panel shape on which a cooking vessel 10 can be placed may be provided.

In addition, at the upper surface 101a of the main body 101, the user interface 130 capable of receiving a control command from a user and the display 140 capable of displaying operation information of the electronic apparatus 100 may be provided. However, the positions of the user interface 130 and the display 140 are not limited to the upper surface 101a of the main body 101, and may be provided at various positions, such as a front surface or a side surface of the main body 101. Further, the user interface 130 and the display 140 may be implemented separated as shown in FIG. 2, but this is merely an embodiment of the disclosure, and the display 140 may be implemented as a touch screen and include the user interface 130.

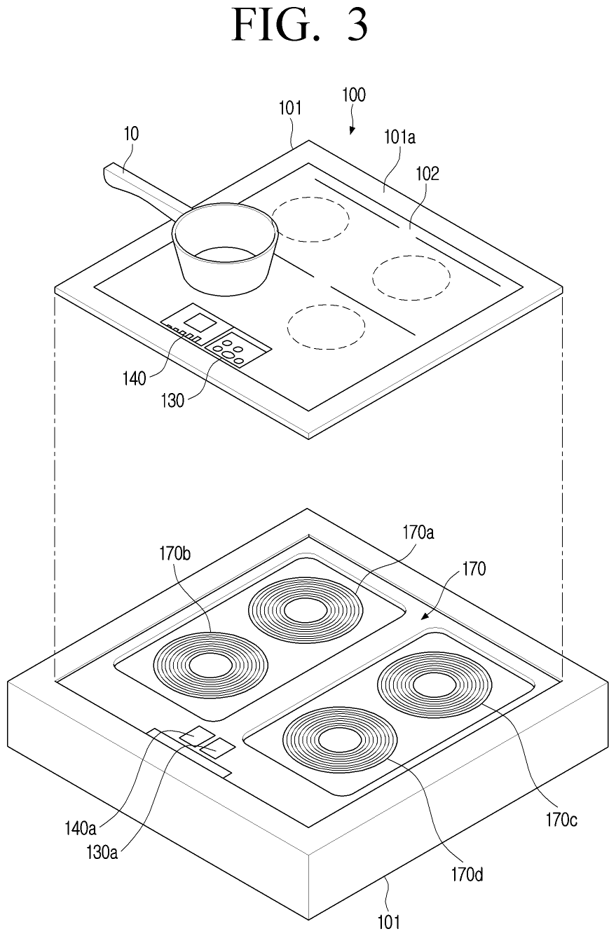

FIG. 3 is a diagram illustrating an inner part of an electronic apparatus according to an embodiment of the disclosure.

Referring to FIG. 3, at a lower part of the cooking plate 102, induction heating coils 170a, 170b, 170c, and 170d for heating a cooking vessel, and a circuit board 140a for implementing the display 140 and a circuit board 130a for implementing the user interface 130 may be provided.

When current is applied to the induction heating coils 170a, 170b, 170c, and 170d, a magnetic field may be induced to heat the cooking vessel by an electromagnetic induction phenomenon. At this time, when alternating current is supplied to the induction heating coils 170a, 170b, 170c, and 170d, a magnetic field that changes in size and direction according to time may be induced at the surrounding of the coil.

The induced magnetic field may pass the cooking plate 102, and reach the cooking vessel 10 placed on the cooking plate 102.

Further, an eddy current which rotates around the magnetic field may occur in the cooking vessel due to the magnetic field induced by the alternating current. Heat by electrical resistance may be generated in the cooking vessel 10 by the eddy current. The heat by electrical resistance may be heat generated at the resistance material when current flows to the resistance material, and may be referred to as joule heat. The cooking vessel 10 may be heated by the heat by electrical resistance as described, and the cooking material contained in the cooking vessel 10 may be heated.

As described above, the electronic apparatus 100 may heat the cooking vessel by using the electromagnetic induction phenomenon and the heat by electrical resistance.

FIGS. 4A and 4B are diagrams illustrating a power supply circuit 150 according to various embodiments of the disclosure.

Referring to FIG. 4A, the power supply circuit 150 may be supplied with input power by an alternating current power source 10. Then, the power supply circuit 150 may convert the input power, and supply the converted power to the induction heating coil 170.

The processor 180 may sense a magnitude of voltage constituting the input power which is supplied to the power supply circuit 150 through a voltage sensor 160a. The processor 180 may sense a magnitude of current constituting the input power which is supplied to the power supply circuit 150 through a current sensor 160b. The processor 180 may sense the magnitude of voltage constituting the supply power which the power supply circuit 150 supplies to the induction heating coil 170 through a voltage sensor 160c. The processor 180 may sense the magnitude of current constituting the supply power which the power supply circuit 150 supplies to the induction heating coil 170 through a current sensor 160d.

Referring to FIG. 4B, the power supply circuit 150 may include a rectifier 151 and an inverter 152. At this time, the rectifier 151 may include a rectifier circuit, and the inverter 152 may include a power conversion circuit.

When an alternating current power source 410 is applied, the rectifier 151 may supply a direct current power to the inverter 152.

When the direct current power is supplied to the inverter 152, the inverter 152 may convert the direct current power to an alternating current power.

At this time, the inverter 152 may include switching elements Q1 and Q2 for adjusting the input power or a frequency of the supply power. At this time, the switching elements may be an insulated gate bipolar mode transistor, but are not limited thereto.

The switching elements Q1 and Q2 may be turned-on and turned-off complementary to each other by a switching signal. Then, capacitors C1 and C2 corresponding to the switching elements may be connected in parallel to the respective switching elements in the inverter 152.

At an input terminal of the power supply circuit 150, the voltage sensor 160a and a current sensor 160b may be provided. Accordingly, the voltage sensor 160a may sense voltage that is applied to the power supply circuit 150. Then, the current sensor 160b may sense current that is supplied to the power supply circuit 150.

In addition, at an output terminal of the power supply circuit 150, the voltage sensor 160c and a current sensor 160d may be provided. Accordingly, the voltage sensor 160c may sense the magnitude of voltage supplied by the power supply circuit 150. Further, the current sensor 160d may sense the magnitude of current supplied by the power supply circuit 150.

Specifically, at a current path between a connection point of the switching elements Q1 and Q2 and a coil, the voltage sensor 160c and the current sensor 160d may be provided. Accordingly, the voltage sensor 160c may sense the magnitude of voltage supplied by the inverter 152 to the induction heating coil 170. Further, the current sensor 160d may sense the magnitude of current supplied by the inverter 152 to the induction heating coil 170.

The processor 180 may control a frequency of current supplied to the power supply circuit 150 or a frequency of current supplied by the inverter 152 to the induction heating coil 170 by controlling an on-off cycle of the switching element.

Meanwhile, the electronic apparatus 100 may include, as shown in FIGS. 4A and 4B, both the voltage sensor 160a and the current sensor 160b for sensing the input power of the power supply circuit 150, and the voltage sensor 160c and the current sensor 160d for sensing the supply power of the power supply circuit 150, but the above is merely one embodiment of the disclosure, and the electronic apparatus 100 may include at least one from among the above-described sensors 160a, 160b, 160c, and 160d.

An operation of the processor 180 according to one or more embodiments of the disclosure will be described below with reference to the accompanied drawings.

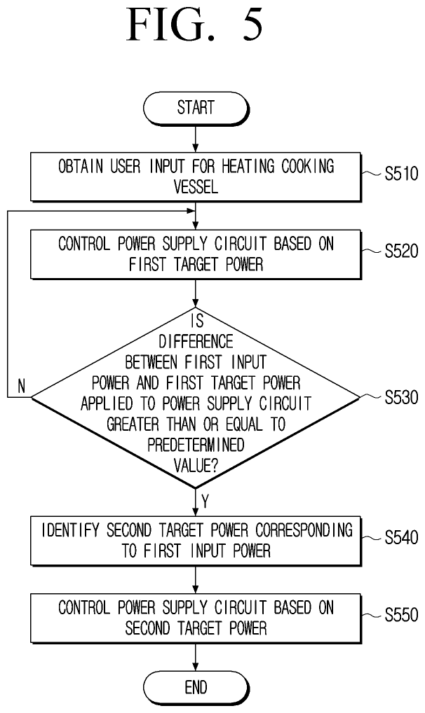

FIG. 5 is a flowchart illustrating a method by which an electronic apparatus controls input power of a power supply circuit according to an embodiment of the disclosure.

Referring to FIG. 5, the processor 180 may obtain a user input for heating a cooking vessel at operation S510. At this time, the processor 180 may obtain the user input for heating the cooking vessel through the user interface 130 or the communication interface 120.

The user input may include information on operation steps (e.g., step 1, step 2, . . . , step n). Here, the operation steps may refer to a magnitude of power input to the power supply circuit 150, a magnitude of power supplied by the power supply circuit 150, an output intensity of the electronic apparatus 100, a magnetic field intensity generated by the induction heating coil 170 or a degree of heating the cooking vessel.

At this time, the operation steps may not be absolute values, and the operation steps may be relative values representing a specific output. For example, an output corresponding to step 2 may be greater than an output corresponding to step 1. Further, the output corresponding to step 2 may be 400 W, and the output corresponding to step 1 may be 200 W.

Meanwhile, the operation steps in the disclosure may be designated as an output level, a power level, an electric power level, a heating level, a heating strength, a heating degree, an output strength, an output degree, and the like.

Further, the processor 180 may identify a first target power corresponding to the user input. The processor 180 may identify the first target power corresponding to a first operation step included in the user input.

At this time, the target power corresponding to the operation step included in the user input may be power which is matched to the operation step included in the user input and stored in the memory 110.

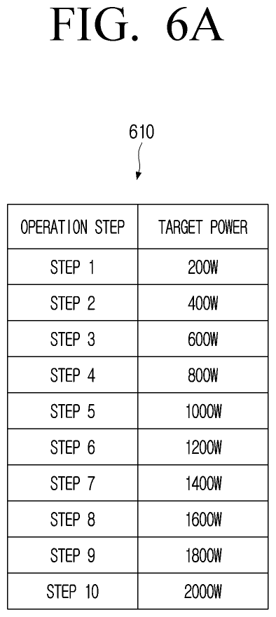

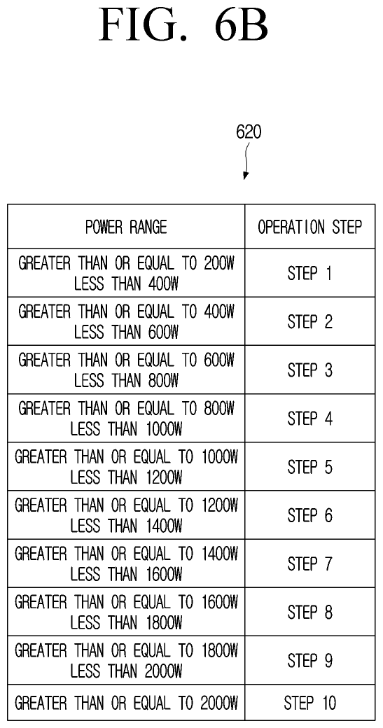

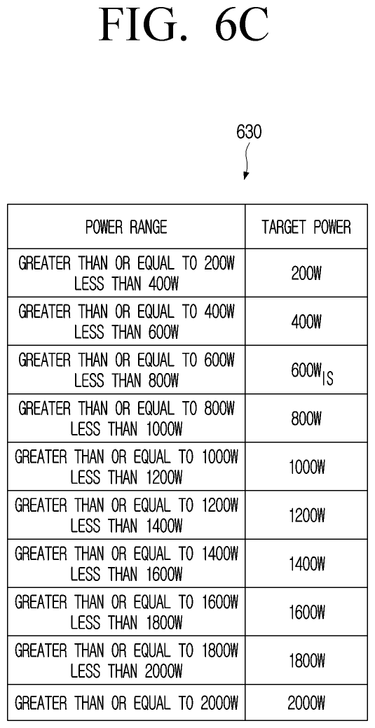

FIGS. 6A, 6B, and 6C are diagrams illustrating information stored in memory according to various embodiments of the disclosure.

Referring to FIG. 6A, the memory 110 may store information 610 on power corresponding respectively to a plurality of operation steps. For example, the memory 110 may store information on power matched respectively to the plurality of operation steps. At this time, an output matched at step 8 of the operation step may be 1700 W, and an output matched at step 9 of the operation step may be 1800 W.

In the disclosure, target power may refer to a target value of power input to the power supply circuit 150. Alternatively, the target power may be the target value of power which the power supply circuit 150 supplies to the induction heating coil 170. For example, the target power may refer to a target value set for the power supply circuit 150 to supply power to the induction heating coil 170.

Then, the processor 180 may control the power supply circuit 150 based on the first target power corresponding to the operation step input by the user at operation S520.

Specifically, the processor 180 may control the power supply circuit 150 for the input power of the power supply circuit 150 to be the first target power. For example, the processor 180 may control the power supply circuit 150 for the input power to reach the first target power.

In the disclosure, the input power of the power supply circuit 150 may refer to power input to the power supply circuit 150.

The processor 180 may control input electric power by controlling an operation of a device constituting the circuitry included in the power supply circuit 150.

The processor 180 may increase the magnitude of current constituting the input power, and increase the input power. The processor 180 may control an operation of a element constituting the circuitry included in the power supply circuit 150.

For example, the processor 180 may control the inverter included in the power supply circuit 150. Specifically, the processor 180 may control an on or off of the switching element constituting the inverter, and control a frequency of current constituting the input power. Specifically, the processor 180 may control the frequency of current applied to the inverter 152 by controlling a number of times the switching element is turned-on and turned-off per unit time. Further, the processor 180 may control the frequency of current constituting the input power, and control the magnitude of current constituting the input power.

Meanwhile, the processor 180 may increase the input power by controlling the magnitude of current constituting the input power, but this is merely one embodiment of the disclosure, and the processor 180 may increase the input power by controlling the magnitude of voltage constituting the input power. At this time, the processor 180 may control the magnitude of voltage constituting the input power by controlling an operation of a device constituting the circuitry included in the power supply circuit 150.

For example, the processor 180 may control the magnitude of voltage constituting the input power using techniques, such as pulse width modulation (PWM) and maximum power point tracking (MPPT).

Alternatively, the processor 180 may control the input power by using a pulse pattern of an input voltage or an input current. For example, the processor 180 may control the input power by using the pulse pattern of the input voltage or the input current. For example, the processor 180 may control the input power by supplying power for a specific time, and using a pattern that blocks power for a specific time.

The input power of the power supply circuit 150 may be obtained by Equation 1 below.

input power=input voltage×input current×cos θ Equation 1

The input voltage may be the magnitude of voltage constituting the input power of the power supply circuit 150.

The input current may be the magnitude of current constituting the input power of the power supply circuit 150.

θ may be a cosine of a power factor angle. Here, the power factor may be a variable that represents an effectiveness and effective power in an electric system. At this time, θ may be a phase difference between the input voltage and the input current.

The processor 180 may identify, through the sensor 160, a magnitude of input voltage constituting the input power, a magnitude of input current, and the phase difference between the input voltage and the input current.

When a cooking vessel is placed in the magnetic field generated by the induction heating coil 170, θ may be determined according to the characteristic of the cooking vessel. Specifically, based on magnetic properties of the cooking vessel being higher, θ may be closer to 0. Based on the magnetic properties of the cooking vessel being lower, θ may be closer to π/2.

Accordingly, the input power may be varied according to the characteristic of the cooking vessel with respect to a specific input voltage and a specific input current. For example, a more higher input voltage or a more higher input current may be required for the power supply circuit 150 to receive input of the target power as θ becomes closer to π/2.

Accordingly, if a high operation step is input for the cooking vessel having low magnetic properties (or, low conduction efficiency), the input current constituting the input power may reach a threshold current prior to the input power reaching the target power. If the input current reaches the threshold current, the threshold current may be continuously applied to the power supply circuit 150.

If the threshold current is continuously applied to the power supply circuit 150, a problem of a temperature of a device constituting the power supply circuit 150 increasing, and the device being damaged may occur. Here, the threshold current may refer to a maximum allowable current, a threshold current, or current which exceeds the maximum allowable current and is less than or equal to the threshold current. The maximum allowable current may be a maximum value of current applicable to the power supply circuit 150 within a safe range of a device constituting the power supply circuit 150. The threshold current may be a maximum value of current applicable by the power supply circuit 150 to the induction heating coil 170 within a safe range of a device constituting the power supply circuit 150. The threshold current may be applied to the power supply circuit 150 prior to the input power that is applied to the power supply circuit 150 becoming the target power. The threshold current may vary according to an operation step or a target step, and information on the threshold current according to the operation step or the target step may be stored in the memory 110. For example, the processor 180 may control the power supply circuit 150 for the input power to increase until the input power supplied to the power supply circuit 150 reaches the target power or the input current constituting the input power reaches the threshold current. The disclosure has been devised to address the above-described issues of the related art, and an object of the disclosure is to readjust the operation step or the target power based on the input power of the power supply circuit 150, and provide an electronic apparatus 100 that controls the power supply circuit 150 based on the readjusted operation step or target power and a method of controlling thereof. In addition, the issue to be addressed by the technical spirit of the disclosure is not limited to the above-mentioned problems, and problems not yet mentioned may be clearly understood by those of ordinary skill in the art from the description below.

For example, to address the above-described issue, there is a need for the input operation step and the target power corresponding to the input operation step to be adjusted to a lower operation step and a lower target power. Accordingly, the processor 180 may adjust, based on a predetermined condition being satisfied, the operation step or the target power based on the input power of the power supply circuit 150. Then, the processor 180 may control the power supply circuit 150 based on the adjusted operation step or target power. Accordingly, the problem of the threshold current being continuously applied to the power supply circuit 150 may be prevented. For example, current of less than the threshold current may be applied to the power supply circuit 150, and a problem of a temperature of a device being maintained at a high temperature state may be prevented.

Specifically, the processor 180 may identify whether a difference between the first input power and the first target power applied to the power supply circuit 150 is greater than or equal to a predetermined value at operation S530. At this time, the first input power may be power input to the power supply circuit 150 when the above-described predetermined condition is satisfied, but is not limited thereto.

Based on the difference between the first input power and the first target power being greater than or equal to the predetermined value at operation S530-Y, the processor 180 may identify a second target power corresponding to the first input power at operation S540.

Specifically, the processor 180 may identify an operation step corresponding to the first input power. At this time, the processor 180 may identify an operation step corresponding to a power range to which the input power belongs. Here, the memory 110 may store information on an operation step corresponding to the power range to which the input power belongs.

For example, referring to FIG. 6B, information 620 on the operation steps corresponding to power ranges to which the input power stored in the memory 110 belongs may be as shown in FIG. 6B. At this time, the power ranges corresponding to the respective operation steps may be greater than or equal to the target power corresponding to the respective operation steps and less than the target power corresponding to the operation step which is one step higher than the respective operation steps. For example, a power range corresponding to step 4 of the operation steps may be power of greater than equal to 800 W corresponding to step 4 of the operation steps, and power of less than 1000 W corresponding to step 5 of the operation steps.

Alternatively, the information 620 on the operation steps corresponding to the power ranges to which the input power belongs shown in FIG. 6B is merely one embodiment of the disclosure, and is not limited thereto. The power ranges corresponding to the respective operation steps may be greater than or equal to a first average power between a target power corresponding to the respective operation steps and a target power corresponding to an operation step which is one step lower than the respective operation steps, and less than a second average power between a target power corresponding to the respective operation steps and a target power corresponding to an operation step which is one step higher than the respective operation steps. For example, the target power corresponding to step 4 of the operation steps may be 800 W. The target power corresponding to step 3 which is one step lower than step 4 of the operation steps may be 600 W. The target power corresponding to step 5 which is one step higher than step 4 of the operation steps may be 1000 W. At this time, the first average power may be 700 W which is an average of 800 W and 600 W. Further, the second average power may be 900 W which is an average of 800 W and 1000 W. At this time, the power range corresponding to step 4 is greater than or equal to 700 W and less than 900 W.

Alternatively, the power ranges corresponding to the respective operation steps may exceed the target power corresponding to the operation step which is one step lower than the respective operation steps, and less than or equal to the target power corresponding to the respective operation steps. For example, the target power corresponding to step 4 of the operation steps may be 800 W. The target power corresponding to step 3 which is one step lower than step 4 of the operation steps may be 600 W. At this time, the power range corresponding to step 4 of the operation steps may be greater than 600 W and less than 800 W.

Accordingly, the processor 180 may identify the second target power corresponding to a second operation step. A method of identifying the second target power corresponding to the second operation step by the processor 180 may be same as the method described above with reference to FIG. 6A, but is not limited thereto.

Alternatively, the processor 180 may identify the second target power corresponding directly to the first input power without an operation of identifying the second operation step. At this time, the processor 180 may identify the operation step corresponding to the power range to which the input power belongs. Here, the memory 110 may store information on the target power corresponding to the power range to which the input power belongs.

For example, referring to FIG. 6C, information 630 on the target power corresponding to the power range to which the input power stored in the memory 110 belongs may be as shown in FIG. 6C. At this time, the power ranges corresponding to the respective target powers may be greater than or equal to the respective target powers, and less than the target power which is one step higher than the respective target powers. For example, the power range corresponding to the target power of 800 W may be a target power of greater than or equal to 800 W, and less than 1000 W which is one step higher than the target power of 800 W.

Meanwhile, information 630 on the operation step corresponding to the power range to which the input power belongs shown in FIG. 6C is merely one embodiment of the disclosure, and is not limited thereto. The power ranges corresponding to the respective target powers may be greater than or equal to an average between the respective target powers and a target power which is one step higher than the respective target powers, and less than an average between the target power which is one step higher than the respective target powers and a target power which is two steps higher than the respective target powers. For example, the power range corresponding to the target power of 800 W may be greater than or equal to 900 W which is an average between the target power of 800 W and 1000 W which is one step higher than the target power of 800 W, and less than 1100 W which an average between 1000 W which is one step higher than the target power of 800 W and 1200 W which is two steps higher than the target power of 800 W. Accordingly, the processor 180 may identify power matched to the power range to which the first input power belongs as the second target power.

When the second target power is identified, the processor 180 may control the power supply circuit 150 based on the second target power at operation S550.

Specifically, the processor 180 may control the power supply circuit 150 for power input to the power supply circuit 150 to reach the second target power.

Meanwhile, as described above, the processor 180 may control the power supply circuit 150 for the input power of the power supply circuit 150 to reach the first target power, or for the input power applied to the power supply circuit 150 to increase until the predetermined condition is satisfied.

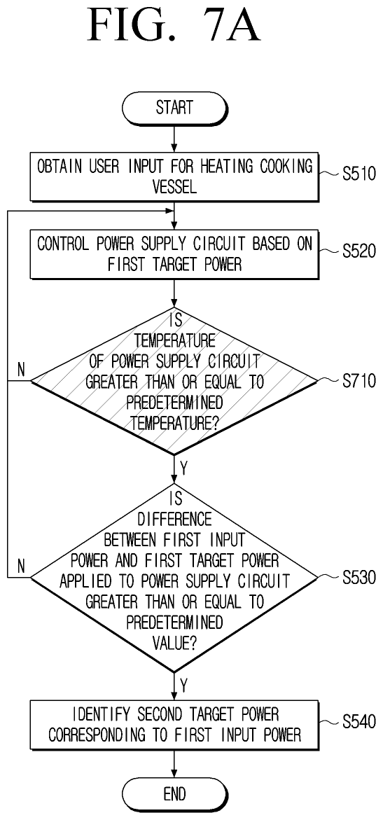

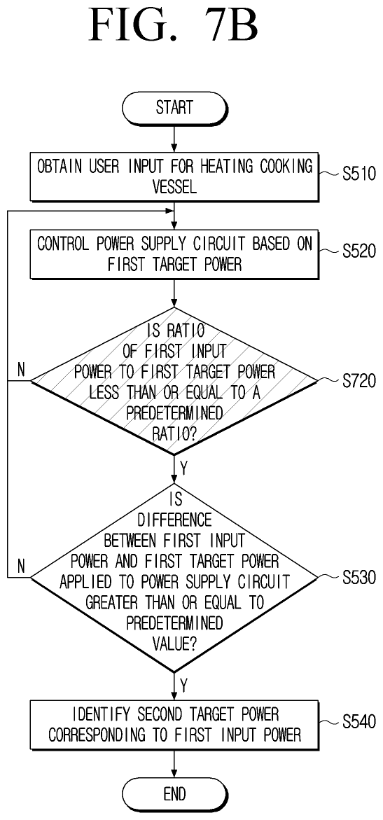

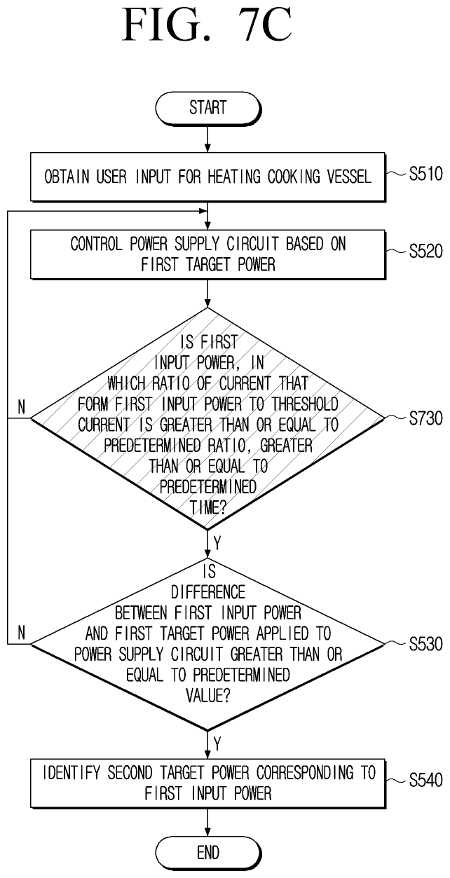

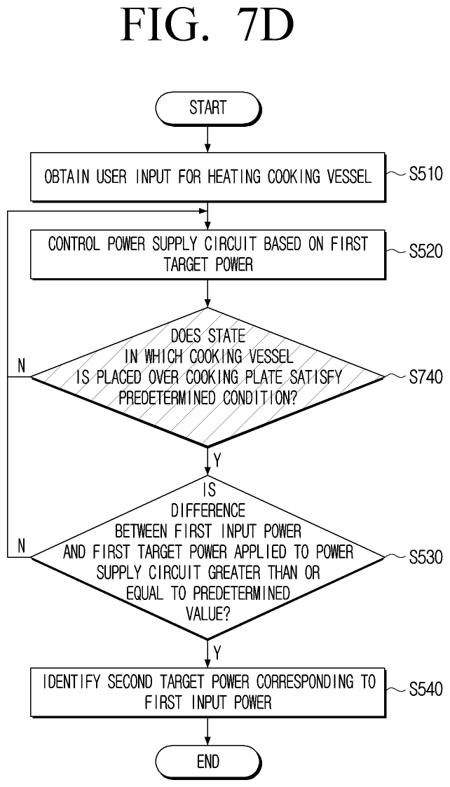

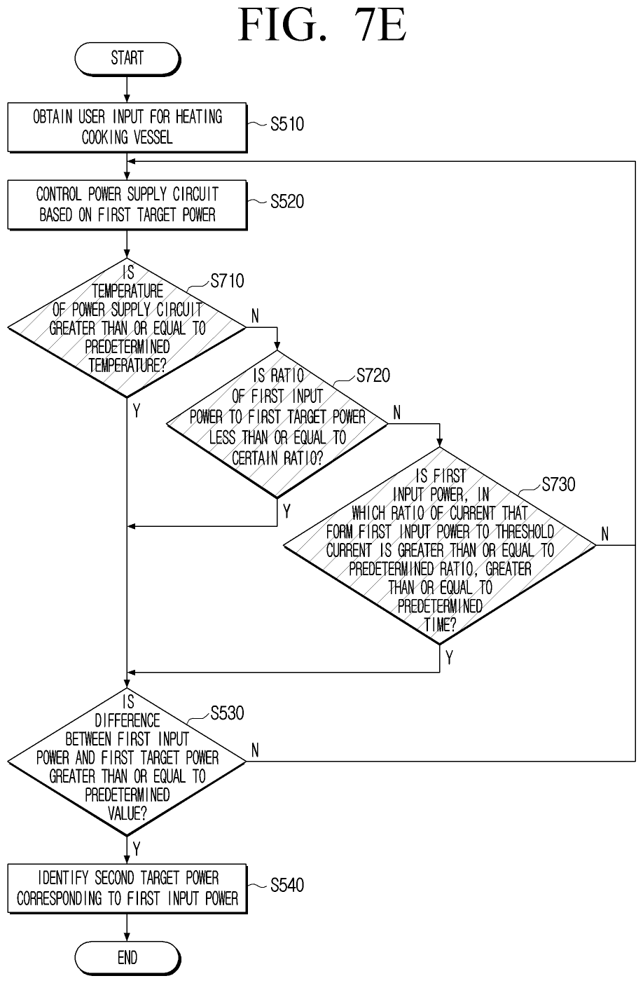

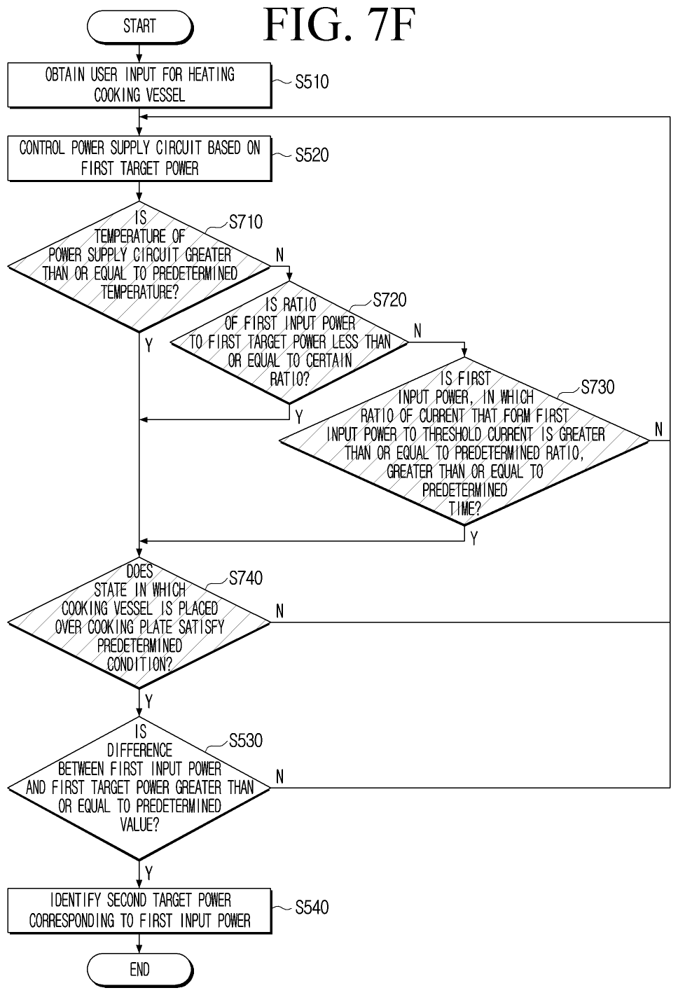

At this time, the predetermined condition may be described with reference to FIGS. 7A, 7B, 7C, 7D, 7E, and 7F.

FIGS. 7A, 7B, 7C, 7D, 7E, and 7F are flowcharts illustrating a method by which the electronic apparatus 100 controls the power supply circuit 150 based on whether the predetermined condition is satisfied according to various embodiments of the disclosure.

FIG. 7A is a flowchart illustrating a method by which an electronic apparatus controls a power supply circuit based on a temperature of a power supply circuit according to an embodiment of the disclosure.

In the disclosure, the temperature of the power supply circuit 150 may refer to a temperature of a device constituting the power supply circuit 150.

Referring to FIG. 7A, the processor 180 may perform operations according to operations S510 and S520.

Then, the processor 180 may identify whether the temperature of the power supply circuit 150 is greater than or equal to a predetermined temperature through the sensor 160 at operation S710. Specifically, the sensor 160 may include a temperature sensor. The processor 180 may sense the temperature of the power supply circuit 150 by using the temperature sensor. The processor 180 may sense a temperature of a device constituting the circuitry included in the power supply circuit 150 by using the temperature sensor.

The processor 180 may identify whether the temperature of the device constituting the power supply circuit 150 is greater than or equal to a predetermined temperature through the sensor 160. At this time, information on the predetermined temperature may be stored in the memory 110.

Based on the temperature of the power supply circuit 150 being less than the predetermined temperature at operation S710-N, the processor 180 may perform an operation according to operation S520.

Based on the temperature of the power supply circuit 150 being greater than or equal to the predetermined temperature at operation S710-Y, the processor 180 may perform operations according to operations S530 and S540. At this time, the operation according to operation S530 may be omitted. For example, based on the temperature of the power supply circuit 150 being greater than or equal to the predetermined temperature at operation S710-Y, the processor 180 may identify the second target power corresponding to the input power which is applied to the power supply circuit 150 at operation S540. Then, the processor 180 may control the power supply circuit 150 based on the second target power.

FIG. 7B is a flowchart illustrating a method of controlling a power supply circuit according to whether an input power applied to a power supply circuit is less than or equal to a predetermined ratio of a first target power when a driving time of a power supply circuit reaches a predetermined time according to an embodiment of the disclosure.

Referring to FIG. 7B, the processor 180 may perform operations according to operations S510 and S520.

Then, the processor 180 may identify, based on the driving time of the power supply circuit 150 reaching the predetermined time, whether the ratio of the first input power which is applied to the power supply circuit 150 to the first target power is less than or equal to the predetermined ratio at operation S720.

Specifically, the processor 180 may identify, based on the driving time of the power supply circuit 150 reaching the predetermined time, the input power applied to the power supply circuit 150. Then, the processor 180 may identify whether the ratio of the input power to the first target power is less than or equal to a predetermined ratio.

Here, the driving time of the power supply circuit 150 may be time at which the processor 180 limits the power supply circuit 150 based on the first target power. For example, the driving time of the power supply circuit 150 may be time at which the processor 180 controls the power supplied circuit 150 based on the first target power.

The predetermined time and predetermined ratio described above may vary according to an operation step input by the user or target power corresponding to the operation step. At this time, the predetermined time and predetermined ratio according to the operation step or the target power may be stored in the memory 110.

For example, the first target power may be 2000 W, the predetermined time according to the first target power may be 30 seconds, and the predetermined ratio may be 70%. Then, when the driving time of the power supply circuit 150 reaches 30 seconds, the power supplied to the power supply circuit 150 may be 800 W. At this time, the ratio of power supplied to the power supply circuit 150 to the first target power may be 800/2000. At this time, the processor 180 may identify the ratio (40%) of power supplied to the power supply circuit 150 to the first target power as less than or equal to the predetermined ratio (70%).

When the driving time of the power supply circuit 150 reaches a predetermined time, the processor 180 may perform, based on the ratio of the first input power of the power supply circuit 150 to the first target power exceeding the predetermined ratio at operation S720-N, the operation according to operation S520.

Then, when the driving time of the power supply circuit 150 reaches the predetermined time, the processor 180 may perform, based on the ratio of the first input power to the first target power being less than or equal to the predetermined ratio at operation S720-Y, the operations according to operations S530 and S540. At this time, the operation according to operation S530 may be omitted. For example, based on the ratio of the first input power to the first target power being less than or equal to the predetermined ratio at operation S720-Y, the processor 180 may identify the second target power corresponding to the input power which is applied to the power supply circuit 150 at operation S540. Then, the processor 180 may control the power supply circuit 150 based on the second target power.

FIG. 7C is a flowchart illustrating a method by which an electronic apparatus controls a power supply circuit based on a magnitude of current constituting an input power of a power supply circuit according to an embodiment of the disclosure.

Referring to FIG. 7C, the processor 180 may perform the operations according to operations S510 and S520.

Then, the processor 180 may identify whether the first input power in which a ratio of current constituting the first input power to the threshold current is greater than or equal to the predetermined ratio is applied to the power supply circuit 150 for the predetermined time or more at operation S730. At this time, the predetermined ratio and predetermined time may vary according to the operation step and the target power. Information on the predetermined ratio and predetermined time according to the operation step or the target power may be stored in the memory 110. For example, the threshold current may be 80 A, the predetermined ratio may be 50%, and the predetermined time may be 30 seconds. At this time, if an input current of 60 A constituting the first input power is applied to the power supply circuit 150 for 30 seconds, the processor 180 may identify that the input power in which the ratio of current constituting the first input power to the threshold current is greater than or equal to the predetermined ratio as having been applied to the power supply circuit 150 for the predetermined time or more. Based on the first input power in which the ratio of current constituting the first input power to the threshold current is greater than or equal to the predetermined ratio not being applied to the power supply circuit 150 for the predetermined time or more at operation S730-N, the processor 180 may perform the operation according to operation S520.

Based on the first input power in which the ratio of current constituting the first input power to the threshold current is greater than or equal to the predetermined ratio being applied to the power supply circuit 150 for the predetermined time or more at operation S730-Y, the processor 180 may perform the operations according to operations S530 and S540. At this time, the operation according to operation S530 may be omitted. For example, when the first input power in which the ratio of current constituting the first input power to the threshold current is greater than or equal to the predetermined ratio is applied to the power supply circuit 150 for greater than or equal to the predetermined time at operation S730-Y, the processor 180 may identify the second target power corresponding to the first input power which is applied to the power supply circuit 150 at operation S540. Then, the processor 180 may control the power supply circuit 150 based on the second target power.

FIG. 7D is a flowchart illustrating a method of controlling a power supply circuit by an electronic apparatus according to whether a state in which a cooking vessel is placed on a cooking plate is maintained for greater than or equal to a certain time according to an embodiment of the disclosure.

Referring to FIG. 7D, the processor 180 may perform operations according to operations S510 and S520. In the disclosure, the processor 180 may identify whether the cooking vessel is placed on the cooking plate prior to performing the operation according to operation S510.

Specifically, the sensor 160 may include a magneto-sensitive sensor. The processor 180 may sense whether the cooking vessel is placed on the cooking plate using the magneto-sensitive sensor.

Alternatively, the sensor 160 may include a weight sensor. If a weight greater than or equal to a predetermined weight is sensed over the cooking plate through the weight sensor, the processor 180 may identify as the cooking vessel being placed on the cooking plate.

If the cooking vessel is placed on the cooking plate, the processor 180 may perform operations according to operations S510 and S520. Further, if the cooking vessel is not placed on the cooking plate, the processor 180 may not control, even when the user input for heating the cooking vessel is obtained, the power supply circuit 150 based on the target power corresponding to the user input.

After performing the operations according to operations S510 and S520, the processor 180 may identify whether the state in which the cooking vessel is placed on the cooking plate satisfies the predetermined condition at operation S740.

At this time, the predetermined condition may be a condition in which the driving of the electronic apparatus 100 is started and the state in which the cooking vessel is placed on the cooking plate is maintained for the predetermined time or more. For example, the predetermined condition may be a condition in which the driving of the electronic apparatus 100 is started and the state in which the cooking vessel is placed on the cooking plate is maintained for 10 seconds or more.

Alternatively, the predetermined condition may be a condition in which the cooking vessel is identified as having been placed on the cooking plate and the state in which the cooking vessel is placed on the cooking plate is maintained for the predetermined time. For example, the predetermined condition may be a condition in which the cooking vessel is identified as having been placed on the cooking plate and the state in which the cooking vessel is placed on the cooking plate is maintained for 10 seconds.

Alternatively, the predetermined condition may be a condition in which the cooking vessel is placed on the cooking plate when the predetermined time is passed after the cooking vessel is identified as having been placed on the cooking plate. For example, the predetermined condition may be a condition in which the cooking vessel is identified as having been placed on the cooking plate, and the cooking vessel is placed on the cooking plate 10 seconds thereafter.

Alternatively, the predetermined condition may be a condition in which time during which the cooking vessel is displaced, while the electronic apparatus 100 is in operation, is less than or equal to a predetermined time. For example, the predetermined condition may be a condition in which the time during which the cooking vessel is displaced while the electronic apparatus 100 is in operation is less than or equal to 10 seconds.

Based on the state in which the cooking vessel is placed on the cooking plate being such that the predetermined condition is not satisfied at operation S740-N, the processor 180 may perform the operation according to operation S520.

Alternatively, based on the state in which the cooking vessel is placed on the cooking plate being such that the predetermined condition is not satisfied at operation S740-N, the processor 180 may stop the operation of the electronic apparatus 100. At this time, the processor 180 may temporarily stop the operation of the electronic apparatus 100 until the cooking vessel is placed on the cooking plate. Then, when the cooking vessel is placed on the cooking plate again, the processor 180 may resume the operation of the electronic apparatus 100. At this time, the processor 180 may perform the operation according to operation S520.

Alternatively, based on the state in which the cooking vessel is placed on the cooking plate being such that the predetermined condition is not satisfied at operation S740-N, the processor 180 may control the power supply circuit 150 based on a predetermined operation step. For example, while the power supply circuit 150 is being controlled based on step 4 of the operation steps, the processor 180 may control the power supply circuit 150 based on step 1 of the predetermined operation step if the state in which the cooking vessel is placed on the cooking plate is such that the predetermined condition is not satisfied.

Meanwhile, based on the state in which the cooking vessel is placed on the cooking plate being such that the predetermined condition is satisfied at operation S740-Y, the processor 180 may perform the operations according to operations S530 and S540. At this time, the operation according to operation S530 may be omitted. For example, if at least one condition from among a plurality of conditions is satisfied, the processor 180 may identify the second target power corresponding to the first input power which is applied to the power supply circuit 150 at operation S540. Then, the processor 180 may control the power supply circuit 150 based on the second target power.

Meanwhile, the predetermined condition according to the disclosure may be a condition which combined at least one condition from among the plurality of conditions described above with reference to FIGS. 7A, 7B, 7C, and 7D.

At this time, the processor 180 may perform the operations according to operations S530 and S540 based on whether the condition which combined at least one condition from among the plurality of conditions is satisfied.

FIGS. 7E and 7F are diagrams illustrating a method of controlling a power supply circuit according to whether an electronic apparatus satisfies a plurality of conditions according to various embodiments of the disclosure.

Referring to FIG. 7E, the processor 180 may perform the operations according to operations S510 and S520.

Then, the processor 180 may identify whether the temperature of the power supply circuit 150 is greater than or equal to the predetermined temperature at operation S710.

Based on the temperature of the power supply circuit 150 being less than or equal to the predetermined temperature at operation S710-N, the processor 180 may identify whether the ratio of the first input power of the power supply circuit 150 to the first target power is less than or equal to the predetermined ratio at operation S720.

Then, based on the ratio of the first input power to the first target power exceeding the predetermined ratio at operation S720-N, the processor 180 may identify whether the first input power in which the ratio of current constituting the first input power to the threshold current is greater than or equal to the predetermined ratio is applied to the power supply circuit 150 for the predetermined time or more at operation S730.

Based on the first input power in which the ratio of current constituting the first input power to the threshold current is greater than or equal to the predetermined ratio not being applied to the power supply circuit 150 for the predetermined time or more at operation S730-N, the processor 180 may perform the operation according to operation S520.

Further, based on the temperature of the power supply circuit 150 being greater than or equal to the predetermined temperature at operation S710-Y, or the ratio of current constituting the first input power to the threshold current being less than or equal to the predetermined ratio at operation S720-Y, or the first input power in which the ratio of current constituting the first input power to the threshold current is greater than or equal to the predetermined ratio being applied to the power supply circuit 150 for the predetermined time or more at operation S730-Y, the processor 180 may perform the operations according to operations S530 and S540. At this time, the operation according to operation S530 may be omitted. For example, when at least one condition from among the plurality of conditions is satisfied, the processor 180 may identify the second target power corresponding to the first input power which is applied to the power supply circuit 150 at operation S540. Then, the processor 180 may control the power supply circuit 150 based on the second target power.

Meanwhile, the processor 180 may identify whether the plurality of conditions are satisfied in an order of operations S710, S720, and S730 as described above, but this is merely one embodiment of the disclosure, and may identify whether the plurality of conditions are satisfied with S710, S720, and S730 in a random order. For example, the processor 180 may identify whether the plurality of conditions are satisfied in the order of S710, S730, and S720.

Then, the processor 180 may identify whether the plurality of conditions are satisfied by performing all operations of S710, S720, and S730, but this is merely one embodiment of the disclosure, and any one from among the conditions according to operations S710, S720, and S730 may be omitted. For example, the processor 180 may identify whether the plurality of conditions are satisfied by omitting an operation according to operation S710, and performing operations according to operations S720 and S730.

FIG. 7F is a flowchart illustrating a method of controlling a power supply circuit by an electronic apparatus according to whether a condition which combined at least one condition from among a plurality of conditions is satisfied according to an embodiment of the disclosure.

Referring to FIG. 7F, the processor 180 may perform the operations according to operations S510 and S520.

Then, the processor 180 may identify whether the temperature of the power supply circuit 150 is greater than or equal to the predetermined temperature at operation S710.

Based on the temperature of the power supply circuit 150 being less than the predetermined temperature at operation S710-N, the processor 180 may identify whether the ratio of the first input power of the power supply circuit 150 to the first target power is less than or equal to the predetermined ratio at operation S720.

Then, based on the ratio of the first input power to the first target power being less than or equal to the predetermined ratio at operation S720-N, the processor 180 may identify whether the first input power, in which the ratio of current constituting the first input current to the threshold current is greater than or equal to the predetermined ratio, is applied to the power supply circuit 150 for the predetermined time or more at operation S730.

Then, based on the first input power in which the ratio of current constituting the first input power to the threshold current is greater than or equal to the predetermined ratio not being applied to the power supply circuit 150 for the predetermined time or more at operation S730-N, the processor 180 may perform the operation according to operation S520.

Further, based on the temperature of the power supply circuit 150 being greater than or equal to the predetermined temperature at operation S710-Y, or the ratio of the input power of the power supply circuit 150 to the first target power being less than or equal to the predetermined ratio at operation S720-Y, or the first input power in which the ratio of current constituting the first input power to the threshold current is greater than or equal to the predetermined ratio being applied to the power supply circuit 150 for the predetermined time or more at operation S730-Y, the processor 180 may identify whether the state in which the cooking vessel is placed on the cooking plate satisfies the predetermined condition at operation S740.

Based on the state in which the cooking vessel is placed on the cooking plate not satisfying the predetermined condition at operation S740-N, the processor 180 may perform the operation according to operation S520.

Further, based on the state in which the cooking vessel is placed on the cooking plate satisfying the predetermined condition at operation S740-Y, the processor 180 may perform the operations according to operations S530 and S540. At this time, the operation according to operation S530 may be omitted. For example, based on the state in which the cooking vessel is placed on the cooking plate satisfying the predetermined condition at operation S740-Y, the processor 180 may identify the second target power corresponding to the first input power which is applied to the power supply circuit 150 at operation S540. Then, the processor 180 may control the power supply circuit 150 based on the second target power.

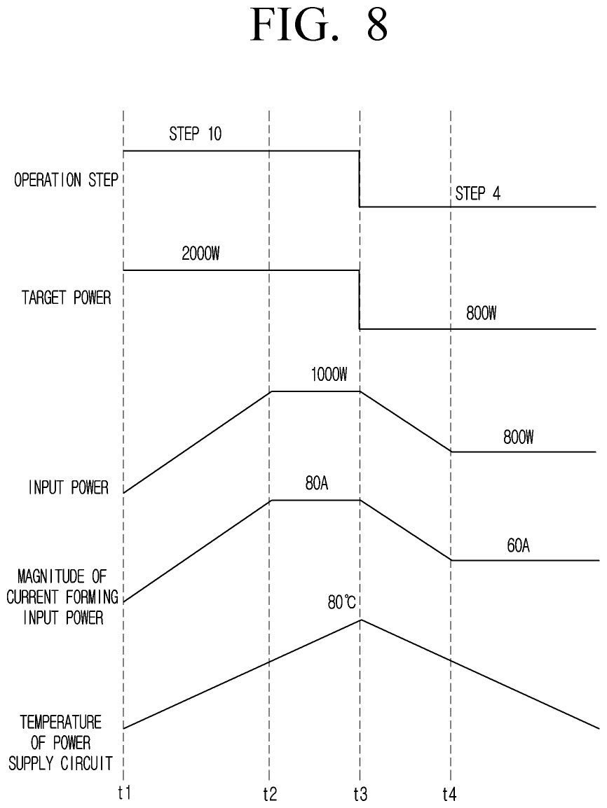

FIG. 8 is a diagram illustrating a change in input power of a power supply circuit according to an embodiment of the disclosure.

Referring to FIG. 8, when a user input including information of the first operation step at t1 time-point being step 10 is obtained, the processor 180 may identify the first target power as 2000 W.

Accordingly, the processor 180 may control the power supply circuit 150 based on the identified first target power.

The processor 180 may control the power supply circuit 150 for the input electric power of the power supply circuit 150 to be 2000 W.

A magnitude of current constituting the input power at t2 time-point may reach a threshold current of 80 A which corresponds to a target power of the first operation step of the power supply circuit 150. Accordingly, the input power of the power supply circuit 150 may be maintained at 1000 W from the t2 time-point. For example, if the magnitude of current constituting the input power reaches the threshold current prior to the input power which is applied to the power supply circuit 150 reaching the target power of the first operation step, the input power of when the magnitude of current constituting the input power reaches the threshold current may be continuously applied to the power supply circuit 150.

Based on the input power of the power supply circuit 150 not being able to reach the target power, the threshold current may be continuously applied to the power supply circuit 150 and the temperature of the power supply circuit may increase. If the temperature of the power supply circuit 150 becomes greater than or equal to the predetermined temperature at t3 time-point, the processor 180 may identify step 4 of the second operation step corresponding to 1000 W which is the input power of the power supply circuit 150 and the second target power of 800 W.

When the target power of 800 W is identified, the processor 180 may control the power supply circuit 150 such that the input power of the power supply circuit 150 becomes 800 W. Accordingly, the input power at t4 time-point may be 800 W, and a likelihood of damage of the power supply circuit 150 may be reduced as the temperature of the power supply circuit 150 is decreased.

Meanwhile, in FIG. 8, the input power, the magnitude of current constituting the input power, and the temperature of the power supply circuit 150 have been shown as linearly increasing or decreasing, but this is merely one embodiment of the disclosure, and the input power, the magnitude of current constituting the input power, and the temperature of the power supply circuit 150 may be non-linearly increased or decreased.

Meanwhile, a problem of the target power being adjusted excessively low for reasons, such as the cooking vessel being displaced from an upper part of the cooking plate for a certain time while the power supply circuit 150 is being driven may occur.

Accordingly, the electronic apparatus 100 may readjust the adjusted target power. Specifically, the electronic apparatus 100 may identify a third target power based on the identified second target power and the temperature of the power supply circuit 150. At this time, the electronic apparatus 100 readjusting the adjusted target power is not limited to when the cooking vessel is displaced from the upper part of the cooking plate for a certain time.

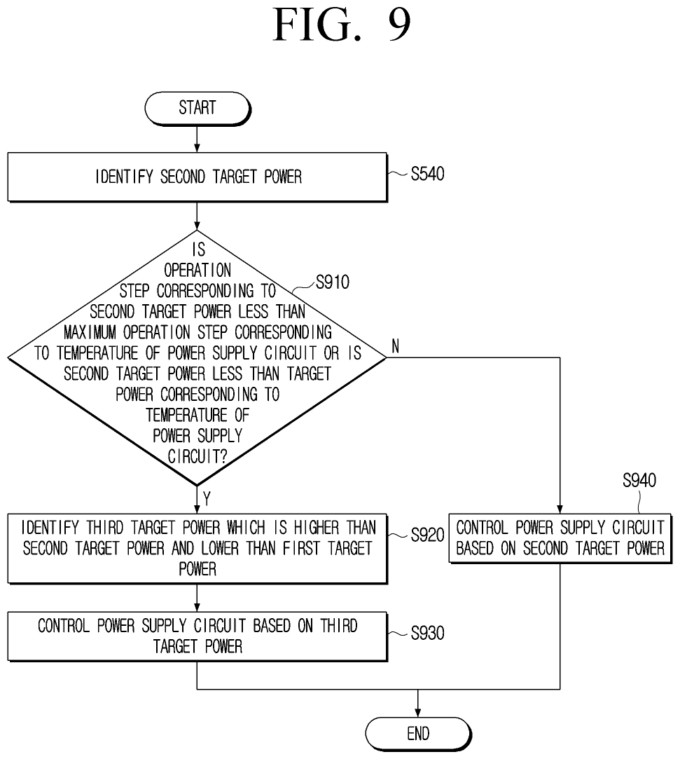

FIG. 9 is a flowchart illustrating a method by which an electronic apparatus readjusts an adjusted target power according to an embodiment of the disclosure.

Referring to FIG. 9, the processor 180 may identify the second target power by performing the operation according to operation S540.

Then, when the second target power is identified, the processor 180 may identify whether an operation step corresponding to the second target power is less than a maximum operation step corresponding to the temperature of the power supply circuit 150 or whether the second target power is less than the target power corresponding to the temperature of the power supply circuit 150 at operation S910.

Here, the maximum operation step may refer to a highest step from among drivable operation steps by the electronic apparatus 100 within the safe range of the device constituting the power supply circuit 150 according to the temperature of the power supply circuit 150.

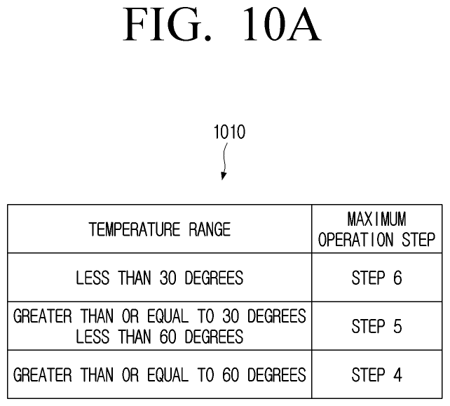

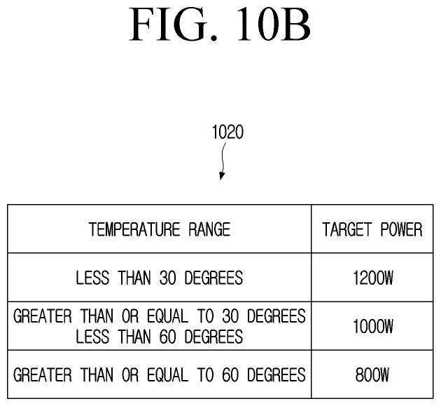

FIGS. 10A and 10B are diagrams illustrating a method by which an electronic apparatus readjusts target power according to temperature of a power supply circuit according to various embodiments of the disclosure.

Specifically, referring to FIG. 10A, the memory 110 may store information 1010 on maximum operation steps of the power supply circuit 150 for a plurality of temperature zones, respectively. For example, the memory 110 may store the information 1010 on the maximum operation steps of the power supply circuit 150 matched with the respective temperature zones.

For example, the operation step corresponding to the second target power may be step 3, and the temperature of the power supply circuit 150 may be 65 degrees. Further, the maximum operation step corresponding to the temperature of the power supply circuit 150 may be step 4. In this case, the processor 180 may identify the operation step corresponding to the second target power as less than the maximum operation step corresponding to the temperature of the power supply circuit 150.

Further, referring to FIG. 10B, the memory 110 may store information 1020 on target powers corresponding to temperatures of the power supply circuit 150. The processor 180 may identify, based on the information 1020 on the target powers corresponding to the temperatures of the power supply circuit 150, a target power corresponding to a temperature of the power supply circuit 150.

For example, the second target power may be 700 W, and the temperature of the power supply circuit 150 may be 65 degrees. At this time, the target power corresponding to the temperature of the power supply circuit 150 may be 800 W. In this case, the processor 180 may identify that the second target power is less than the target power corresponding to the temperature of the power supply circuit 150.

Based on the operation step corresponding to the second target power being identified as less than the maximum operation step corresponding to the temperature of the power supply circuit 150 or the second target power being identified as less than the target power corresponding to the temperature of the power supply circuit 150 at operation S910-Y, the processor 180 may identify the third target power as higher than the second target power and lower than the first target power at operation S920.

Specifically, the processor 180 may identify a third operation step which is higher than the second operation step corresponding to the second target power and lower than the first operation step corresponding to the first target power. Then, the processor 180 may identify the third target power based on a third operation step. At this time, the third operation step may be the maximum operation step corresponding to the temperature of the power supply circuit 150.

Based on the third target power being identified, the processor 180 may control the power supply circuit 150 based on the third target power at operation S930.

Then, based on the operation step corresponding to the second target power being identified as greater than or equal to the maximum operation step corresponding to the temperature of the power supply circuit 150 or the second target power being identified as greater than or equal to the target power corresponding to the temperature of the power supply circuit 150 at operation S910-N, the processor 180 may perform the operation according to operation S550 at operation S940.

Meanwhile, when the power supply circuit 150 is driven based on the second target power, the temperature of the power supply circuit 150 may be decreased. When the temperature of the power supply circuit 150 is decreased, the processor 180 may control the power supply circuit 150 by readjusting the target power.

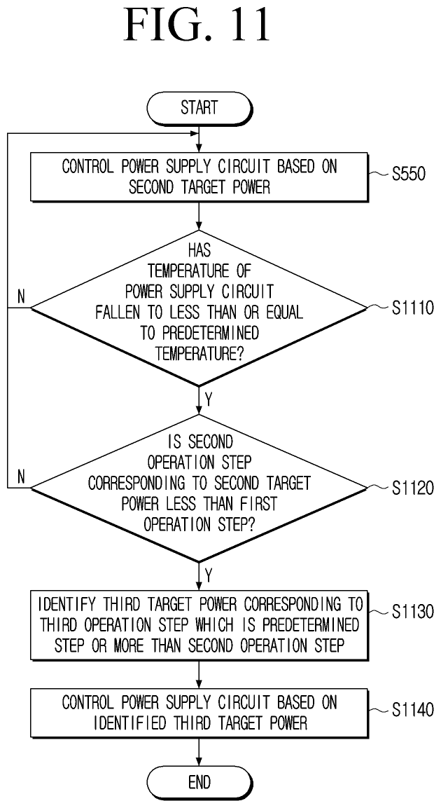

FIG. 11 is a flowchart illustrating a method by which an electronic apparatus re-adjusts target power based on temperature of a power supply circuit according to an embodiment of the disclosure.

Referring to FIG. 11, the processor 180 may perform the operation according to operation S550.

The processor 180 may sense a change in temperature of the power supply circuit 150 while controlling the power supply circuit 150 based on the second target power.

Then, the processor 180 may identify whether the temperature of the power supply circuit 150 falls less than or equal to the predetermined temperature at operation S1110.

Based on the temperature of the power supply circuit 150 not falling to less than or equal to the predetermined temperature at operation S1110-N, the processor 180 may perform the operation according to operation S550.

Based on the temperature of the power supply circuit 150 falling to less than or equal to the predetermined temperature at operation S1110-Y, the processor 180 may identify whether the second operation step corresponding to the second target power is less than the first operation step corresponding to the first target power at operation S1120.

Then, based on the second operation step being less than the first operation step at operation S1120-Y, the processor 180 may identify the third target power corresponding to the third operation step which is a predetermined step or more than the second operation step at operation S1130.

For example, if the second operation step is step 4, and the predetermined step is step 1, the processor 180 may identify step 5 as the third operation step. Then, the processor 180 may identify the third target power corresponding to the third operation step.

Based on the third target power being identified, the processor 180 may control the power supply circuit 150 based on the third target power at operation S1140. Accordingly, the input power closest to the first operation step input by the user within the safe range of the device of the power supply circuit 150 may be applied to the power supply circuit 150.

Meanwhile, an operation according to operation S1120 may be omitted. For example, if the temperature of the power supply circuit 150 falls to less than or equal to the predetermined temperature, the processor 180 may identify the third target power corresponding to the third operation step which is a predetermined step or more than the second operation step. Then, the processor 180 may control the power supply circuit 150 based on the third target power. At this time, the third operation step which is the adjusted operation step or the third target power corresponding to the third operation step may be less than or equal to the first operation step or the first target power. When the third operation step or the third target power exceeds the first operation step or the first target power, the processor 180 may readjust the third operation step or the third target power to the first operation step or the first target power.

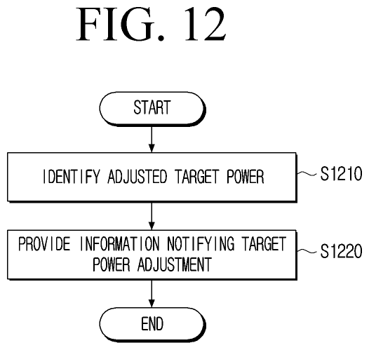

FIG. 12 is a flowchart illustrating a method by which an electronic apparatus provides information notifying that target power or an operation step has been adjusted according to an embodiment of the disclosure.

Referring to FIG. 12, the processor 180 may identify the adjusted target power (the second target power or the third target power) according to the above-described method at operation S1210. Alternatively, the processor 180 may identify the adjusted operation step (the second operation step or the third operation step). Further, the processor 180 may identify the adjusted target power from the adjusted operation step.

Based on the adjusted target power being identified, the processor 180 may provide information on the target power adjustment at operation S1220. Specifically, based on the second target power being identified, the processor 180 may provide information notifying that the target power of the power supply circuit 150 has been adjusted from the first target power to the second target power. Alternatively, based on the second operation step being identified, the processor 180 may provide information notifying that the operation step of the power supply circuit 150 has been adjusted from the first operation step to the second operation step.

At this time, the provided information may include information on a reason the target power or the operation step has been adjusted (e.g., use of a low-efficiency vessel or increase in temperature of the power supply circuit 150) and result of the target power or the operation step being adjusted (e.g., the operation step being adjusted from step 8 to step 4).

Based on the third target power being identified, the processor 180 may provide information notifying that the target power of the power supply circuit 150 has been adjusted from the second target power to the third target power. Alternatively, based on the third operation step being identified, the processor 180 may provide information notifying that the operation step of the power supply circuit 150 has been adjusted from the second operation step to the third operation step.

Specifically, the processor 180 may control the display 140 to display a user interface (UI) notifying that the target power or the operation step of the power supply circuit 150 has been adjusted.

Meanwhile, although the processor 180 may control the power supply circuit 150 based on the adjusted target power, and provide a notification on the change in target power, the above is merely one embodiment of the disclosure, and the processor 180 may provide the user with information for receiving input of whether to adjust the target power, and determine whether to adjust the target power based on a response obtained from the user.

Specifically, the processor 180 may provide the user with a screen or a voice for receiving input of whether to adjust the operation step or the target power. Then, the processor 180 may obtain a user input for receiving input of whether to adjust the operation step or the target power. Based on a user input for changing the operation step or the target power being obtained or the user input not being obtained within a predetermined time, the processor 180 may control the power supply circuit 150 based on the adjusted target power. Then, based on a user input for not adjusting the target power being obtained, the processor 180 may stop the operation of the electronic apparatus 100 for safety.

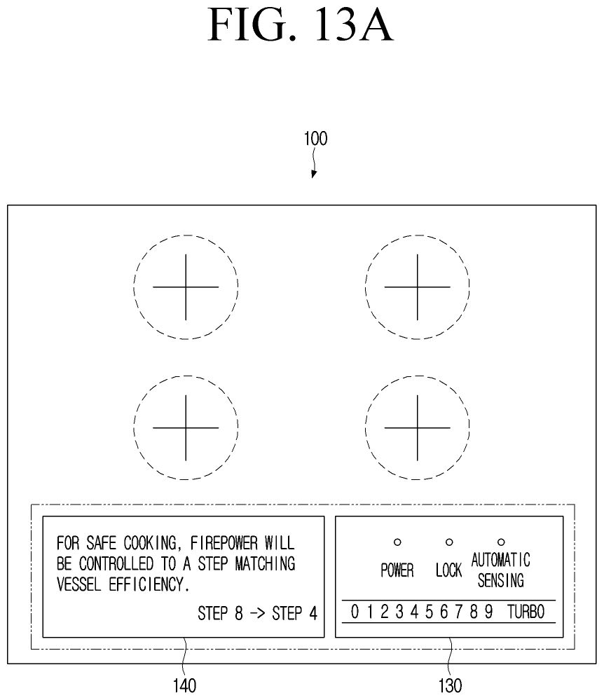

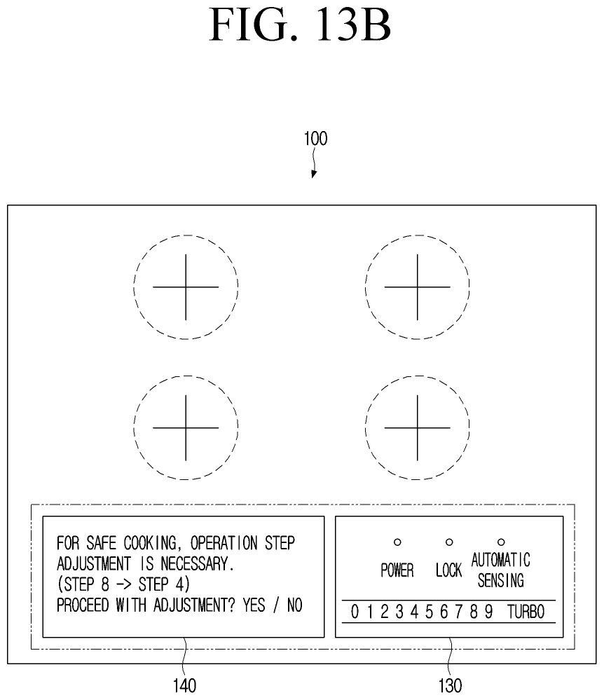

FIGS. 13A and 13B are diagrams illustrating a method by which an electronic apparatus provides information notifying that target power or an operation step of a power supply circuit has been adjusted according to various embodiments of the disclosure.

Referring to FIG. 13A, the processor 180 may control the display 140 to display a UI including information, such as “For safe cooking, firepower will be controlled with output corresponding to vessel efficiency. Step 8→Step 4”

Alternatively, referring to FIG. 13B, the processor 180 may control the display 140 to display a UI including information, such as “For safe cooking, an operation step adjustment is necessary. Proceed with adjustment?”

Alternatively, the processor 180 may control a speaker to output a voice notifying that the target power or the operation step of the power supply circuit 150 has been adjusted. At this time, the speaker may be a configuration included in the electronic apparatus 100. For example, the processor 180 may control the speaker to output a voice, such as “For safe cooking, firepower will be controlled with output corresponding to vessel efficiency. The operation step has been adjusted from step 8 to step 4.”

Alternatively, the processor 180 may control the speaker to output a voice, such as “For safe cooking, an operation step adjustment is necessary. Proceed with adjustment?”

Alternatively, the processor 180 may control the communication interface 120 to transmit information notifying that the target power or the operation step of the power supply circuit 150 has been adjusted to an external device. Specifically, the processor 180 may control the communication interface 120 to transmit information notifying that the input power of the power supply circuit 150 has been adjusted to the external device. Accordingly, the external device may provide information notifying that the target power or the operation step of the power supply circuit 150 has been adjusted.

Alternatively, the processor 180 may control the communication interface 120 to transmit information for receiving input of whether the operation step or the target power has been adjusted to the external device. Accordingly, the external device may provide information for receiving input of whether the operation step or the target power has been adjusted. Then, the processor 180 may receive a user input for whether to adjust the operation step or the target power from the external device through the communication interface 120.

At this time, the external device may provide, though the display or the speaker, information notifying that the target power or the operation step of the power supply circuit 150 has been adjusted, or a UI or a voice inquiring as to whether to adjust the target power or the operation step, but is not limited thereto.

Meanwhile, the processor 180 may perform at least one operation from among an operation of displaying a UI notifying that the target power or the operation step of the power supply circuit 150 has been adjusted, an operation of outputting a voice, and an operation of receiving information together therewith. In addition, the processor 180 may perform at least one from among an operation of displaying a UI for receiving input of whether to adjust the operation step or the target power, an operation of outputting a voice, and an operation of receiving information together therewith. At this time, the processor 180 may simultaneously or consecutively perform at least one from among the above-described operations.

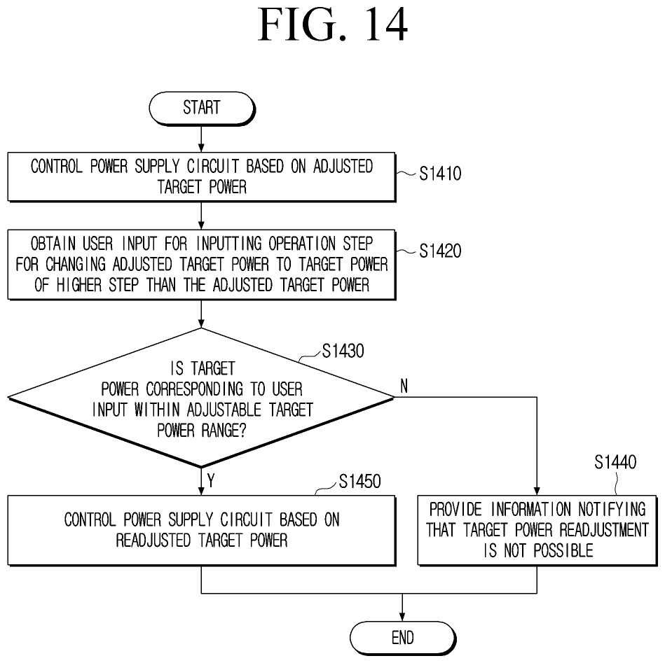

FIG. 14 is a flowchart illustrating a method by which an electronic apparatus operates when a user input for readjusting an operation step (or the target power) is obtained according to an embodiment of the disclosure.

Referring to FIG. 14, the processor 180 may control the power supply circuit 150 based on the adjusted target power at operation S1410.

While the power supply circuit 150 is being controlled based on the adjusted target power, the processor 180 may obtain a user input for changing the adjusting target power to a target power higher than the adjusted target power at operation S1420. At this time, the user input may be a user input for inputting an operation step of a step higher than the operation step corresponding to the adjusted target power.

The processor 180 may identify whether the target power corresponding to the user input is within an adjustable target power range at operation S1430. Specifically, the processor 180 may identify whether the operation step included in the user input is less than or equal to the maximum operation step corresponding to the temperature of the power supply circuit 150. Alternatively, the processor 180 may identify whether the target power corresponding to the operation step included in the user input is less than or equal to the target power corresponding to the temperature of the power supply circuit 150.

Based on the target power corresponding to the user input being outside the adjustable target power range at operation S1430-N, the processor 180 may provide a pre-provided alarm again at operation S1220, or provide information notifying that the operation step (or the target power) readjustment is not possible at operation S1440.

Accordingly, based on a user input for readjusting to a target power higher than the adjusted target power by the user being obtained without changes in a cooking environment, such as the target power being adjusted, and the displaced cooking vessel being placed back over the cooking plate, the processor 180 may maintain the adjusted target power.

Based on the operation step input from the user being within an adjustable operation step range at operation S1430-Y, the processor 180 may control the power supply circuit 150 based on the readjusted target power at operation S1450. Specifically, the processor 180 may readjust the adjusted target power to a target power corresponding to the operation step input from the user. Then, based on the readjusted target power, the processor 180 may control the power supply circuit 150.

Meanwhile, the processor 180 may provide, prior to obtaining the user input for changing the adjusted target power to a target power higher than the adjusted target power, information on the adjustable operation step range. For example, the processor 180 may display a range of the adjustable operation steps on the user interface 130 through the display 140 or the user interface 130. Alternatively, the processor 180 may display information on the maximum operation step from among the adjustable operation steps through the display 140 or the user interface 130. Then, when the user input for the operation step falling within the adjustable operation step range is obtained, the processor 180 may readjust the adjusted target power to a target power corresponding to the operation step included in the user input.

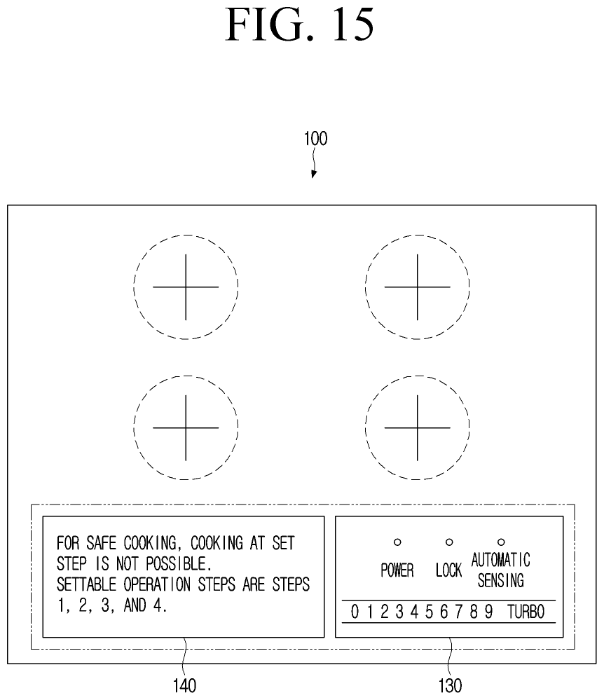

FIG. 15 is diagrams illustrating a method by which an electronic apparatus operates when a user input for re-adjusting an operation step (or target power) is obtained according to an embodiment of the disclosure.

Alternatively, referring to FIG. 15, the processor 180 may provide, at operation S1430-N, information on the adjustable operation step range together with information notifying that the operation step (or the target power) readjustment is not possible. For example, the processor 180 may display a screen, such as “For safe cooking, it is not possible to cook at the set step. Settable operation steps are steps 1, 2, 3, and 4.” Then, when the user input for selecting one from among the settable operation steps is obtained, the processor 180 may control the power supply circuit 150 based on the input operation step.

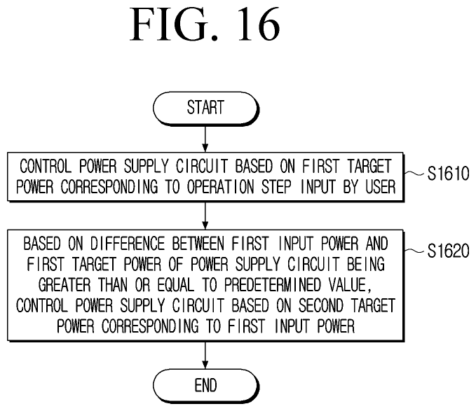

FIG. 16 is a flowchart illustrating a method of controlling an electronic apparatus according to an embodiment of the disclosure.

Referring to FIG. 16, the electronic apparatus 100 may control the power supply circuit 150 based on the first target power corresponding to the operation step input by the user at operation S1610.

The electronic apparatus 100 may identify, based on the input power of the power supply circuit 150 being increased to the first input power, and the predetermined condition being satisfied, whether the difference between the first input power and the first target power is greater than or equal to the predetermined value.

Specifically, the electronic apparatus 100 may identify, based on the temperature of the power supply circuit 150 being greater than or equal to the predetermined temperature, whether the difference between the first input power and the first target power is greater than or equal to the predetermined value.

The electronic apparatus 100 may identify, based on the driving time of the power supply circuit 150 passing a certain time and the ratio of the first input power to the first target power being less than or equal to the predetermined ratio, whether the difference between the first input power and the first target power is greater than or equal to the predetermined value.

The electronic apparatus 100 may identify, based on the driving time of the power supply circuit 150 passing a certain time and the ratio of current constituting the first input power to the threshold current being greater than or equal to the predetermined ratio, whether the difference between the first input power and the first target power is greater than or equal to the predetermined value.

The electronic apparatus 100 may identify, based on sensing the cooking vessel placed on the cooking plate, and the state in which the cooking vessel is placed on the cooking plate being maintained for a certain time, whether the difference between the first input power and the first target power is greater than or equal to the predetermined value.

The electronic apparatus 100 may identify whether the temperature of the power supply circuit 150 is greater than or equal to the predetermined temperature, and identify, based on the temperature of the power supply circuit 150 being less than the predetermined temperature, whether a first driving time of the power supply circuit 150 passes a predetermined first time and whether the ratio of the first input power to the first target power exceeds a predetermined first ratio. Then, the electronic apparatus 100 may identify, based on the ratio of the first input power to the first target power exceeding the predetermined ratio, whether a second driving time of the power supply circuit 150 passes a predetermined second time and whether the ratio of current constituting the first input power to the threshold current of the power supply circuit 150 is greater than or equal to a predetermined second ratio. Then, the electronic apparatus 100 may identify, based on the ratio of current constituting the first input power to the threshold current of the power supply circuit 150 being greater than or equal to the predetermined second ratio, whether the state in which the cooking vessel is placed on the cooking plate is maintained for greater than or equal to a predetermined third time. Then, the electronic apparatus 100 may identify, based on the state in which the cooking vessel is placed on the cooking plate being maintained for greater than or equal to the predetermined third time, whether the difference between the first input power and the first target power is greater than or equal to the predetermined value.

Then, based on the difference between the first input power of the power supply circuit 150 and the first target power being greater than or equal to the predetermined value, the electronic apparatus 100 may control the power supply circuit 150 based on the second target power corresponding to the first input power at operation 81620.

The electronic apparatus 100 may control, based on the second target power being less than the target power corresponding to the temperature of the power supply circuit 150, the power supply circuit 150 based on the third target power which is higher than the second target power and lower than the first target power.

The electronic apparatus 100 may control, based on the temperature of the power supply circuit 150 falling to less than or equal to the predetermined temperature, the power supply circuit 150 based on the third target power which is higher than the second target power.

The electronic apparatus 100 may provide, based on the second target power or the third target power being identified, information notifying that the target power or the operation step of the electronic apparatus 100 has been changed.

The electronic apparatus 100 may increase the input power of the power supply circuit 150 by increasing the magnitude of current constituting the power output by the power supply circuit 150.

The power supply circuit 150 may include at least one switching element for supplying an alternating current power to the induction heating coil 170. At this time, the switching element may be an insulated gate bipolar mode transistor.

Meanwhile, in the one or more embodiments described above, the input power of the power supply circuit 150 may be substituted with the supply power (or, output power) of the power supply circuit 150.

For example, the electronic apparatus 100 according to the disclosure may adjust the operation step or the target power by comparing the input power of the power supply circuit 150 with the target power, and control the power supply circuit 150 based on the adjusted operation step and target power, but the above is not limited thereto, and according to one or more embodiments of the disclosure, the electronic apparatus 100 may adjust the operation step or the target power by comparing the supply power of the power supply circuit 150 with the target power, and control the power supply circuit 150 based on the adjusted operation step and target power.

At this time, a method by which the electronic apparatus 100 adjusts the operation step or the target power by comparing the supply power of the power supply circuit 150 with the target power may be same as a method by which the electronic apparatus 100 adjusts the operation step or the target power by comparing the input power of the power supply circuit 150 with the target power.

Meanwhile, the term “part” or “module” used in the disclosure may include a unit formed of hardware, software, or firmware, and may be used interchangeably with terms, such as, for example, and without limitation, logic, logic blocks, components, circuits, or the like. “Part” or “module” may be a component integrally formed or a minimum unit or a part of the component performing one or more functions. For example, a module may be formed as an application-specific integrated circuit (ASIC).

The various embodiments described above may be implemented with software including instructions stored in a machine-readable storage media (e.g., computer). The machine may call an instruction stored in the storage medium, and as a device operable according to the called instruction, may include the electronic apparatus 100 according to the above-mentioned embodiments. Based on the instruction being executed by the processor, the processor may directly or using other elements under the control of the processor perform a function corresponding to the instruction. The instruction may include a code generated by a compiler or executed by an interpreter. The machine-readable storage medium may be provided in the form of a non-transitory storage medium. Herein, ‘non-transitory’ merely means that the storage medium is tangible and does not include a signal, and the term does not differentiate data being semi-permanently stored or being temporarily stored in the storage medium.

According to one or more embodiments of the disclosure, a method according to the various embodiments described above may be provided included a computer program product. The computer program product may be exchanged between a seller and a purchaser as a commodity. The computer program product may be distributed in the form of a machine-readable storage medium (e.g., compact disc read only memory (CD-ROM)), or distributed online through an application store (e.g., PLAYSTORE™). In the case of online distribution, at least a portion of the computer program product may be stored at least temporarily in the storage medium, such as a server of a manufacturer, a server of an application store, or memory of a relay server, or temporarily generated.

Each of the elements (e.g., a module or a program) according to various embodiments may be formed as a single entity or a plurality of entities, and some sub-elements of the above-mentioned sub-elements may be omitted, or other sub-elements may be further included in the various embodiments. Alternatively or additionally, some elements (e.g., modules or programs) may be integrated into one entity to perform the same or similar functions performed by the respective elements prior to integration. Operations performed by a module, a program, or another element, in accordance with various embodiments, may be executed sequentially, in a parallel, repetitively, or in a heuristic manner, or at least some operations may be executed in a different order, omitted or a different operation may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus comprising:
a user interface;
a cooking plate on which a cooking vessel can be placed;
an induction heating coil configured to induce a magnetic field on the cooking plate;
a power supply circuit configured to supply power to the induction heating coil;
memory storing one or more computer programs; and
one or more processors communicatively coupled to the user interface, the cooking plate, the induction heating coil, and the power supply circuit,
wherein the one or more computer programs include computer-executable instructions that, when executed by the one or more processors cause the electronic apparatus to:
control the power supply circuit based on a first target power corresponding to an operation step input by a user through the user interface, and
control, based on a difference between a first input power of the power supply circuit and the first target power being greater than or equal to a predetermined value, the power supply circuit based on a second target power corresponding to the first input power of the power supply circuit.

2. The electronic apparatus of claim 1, wherein the one or more computer programs further include computer-executable instructions that, when executed by the one or more processors, cause the electronic apparatus to:
increase an input power of the power supply circuit to first input electric power; and
identify, based on a predetermined condition being satisfied, whether the difference between the first input power and the first target power is greater than or equal to the predetermined value.

3. The electronic apparatus of claim 2, wherein the one or more computer programs further include computer-executable instructions that, when executed by the one or more processors, cause the electronic apparatus to:
identify, based on a temperature of the power supply circuit being greater than or equal to a predetermined temperature, whether the difference between the first input power and the first target power is greater than or equal to the predetermined value.

4. The electronic apparatus of claim 2, wherein the one or more computer programs further include computer-executable instructions that, when executed by the one or more processors, cause the electronic apparatus to:
identify, based on a driving time of the power supply circuit exceeding a certain time and a ratio of the first input power to the first target power being less than or equal to a predetermined ratio, whether the difference between the first input power and the first target power is greater than or equal to the predetermined value.

5. The electronic apparatus of claim 2, wherein the one or more computer programs further include computer-executable instructions that, when executed by the one or more processors, cause the electronic apparatus to:
identify, based on a driving time of the power supply circuit exceeding a certain time and a ratio of current constituting the first input power to a threshold current of the power supply circuit being greater than or equal to a predetermined ratio, whether the difference between the first input power and the first target power is greater than or equal to the predetermined value.

6. The electronic apparatus of claim 2, wherein the one or more computer programs further include computer-executable instructions that, when executed by the one or more processors, cause the electronic apparatus to:
sense the cooking vessel placed on the cooking plate; and
identify, based on a state in which the cooking vessel is placed on the cooking plate being maintained for a certain time, whether the difference between the first input power and the first target power is greater than or equal to the predetermined value.

7. The electronic apparatus of claim 2, wherein the one or more computer programs further include computer-executable instructions that, when executed by the one or more processors, cause the electronic apparatus to:
identify whether a temperature of the power supply circuit is greater than or equal to a predetermined temperature;
identify, based on the temperature of the power supply circuit being less than the predetermined temperature, whether a first driving time of the power supply circuit exceeds a predetermined first time and whether a ratio of the first input power to the first target power exceeds a predetermined first ratio;
identify, based on the ratio of the first input power to the first target power exceeding a predetermined ratio, whether a second driving time of the power supply circuit exceeds a predetermined second time, and a ratio of current constituting the first input power to a threshold current of the power supply circuit is greater than or equal to a predetermined second ratio;
identify, based on the ratio of current constituting the first input power to the threshold current of the power supply circuit being greater than or equal to the predetermined second ratio, whether a state in which the cooking vessel is placed on the cooking plate is maintained for a predetermined third time or more; and
identify, based on the state in which the cooking vessel is placed on the cooking plate being maintained for the predetermined third time or more, whether the difference between the first input power and the first target power is greater than or equal to the predetermined value.

8. The electronic apparatus of claim 1, wherein the one or more computer programs further include computer-executable instructions that, when executed by the one or more processors, cause the electronic apparatus to:
control, based on the second target power being less than a target power corresponding to a temperature of the power supply circuit, the power supply circuit based on a third target power which is higher than the second target power and lower than the first target power.

9. The electronic apparatus of claim 1, wherein the one or more computer programs further include computer-executable instructions that, when executed by the one or more processors, cause the electronic apparatus to:
control, based on a temperature of the power supply circuit falling to less than or equal to a predetermined temperature, the power supply circuit based on a third target power which is higher than the second target power.

10. The electronic apparatus of claim 1, wherein the one or more computer programs further include computer-executable instructions that, when executed by the one or more processors, cause the electronic apparatus to:
provide, based on the second target power being identified, information notifying that a target power of the electronic apparatus has been changed.

11. The electronic apparatus of claim 1, wherein the one or more computer programs further include computer-executable instructions that, when executed by the one or more processors, cause the electronic apparatus to:
increase an input power of the power supply circuit by increasing a magnitude of current constituting the power output by the power supply circuit.

12. The electronic apparatus of claim 1, wherein the power supply circuit comprises:
at least one switching element for supplying an alternating current power to the induction heating coil.

13. The electronic apparatus of claim 12, wherein the switching element is an insulated gate bipolar mode transistor.

14. A method of controlling an electronic apparatus, the method comprising:
controlling a power supply circuit based on a first target power corresponding to an operation step input by a user; and
controlling, based on a difference between a first input power of the power supply circuit and the first target power being greater than or equal to a predetermined value, the power supply circuit based on a second target power corresponding to the first input power of the power supply circuit.

15. The method of claim 14, further comprising:
increasing an input power of the power supply circuit to first input electric power; and
identifying, based on a predetermined condition being satisfied, whether the difference between the first input power and the first target power is greater than or equal to the predetermined value.

16. The method of claim 15, further comprising:
identifying, based on a temperature of the power supply circuit being greater than or equal to a predetermined temperature, whether the difference between the first input power and the first target power is greater than or equal to the predetermined value.

17. The method of claim 15, further comprising:
identifying, based on a driving time of the power supply circuit exceeding a certain time and a ratio of the first input power to the first target power being less than or equal to a predetermined ratio, whether the difference between the first input power and the first target power is greater than or equal to the predetermined value.

18. The method of claim 15, further comprising:
identifying, based on a driving time of the power supply circuit exceeding a certain time and a ratio of current constituting the first input power to a threshold current of the power supply circuit being greater than or equal to a predetermined ratio, whether the difference between the first input power and the first target power is greater than or equal to the predetermined value.

19. One or more non-transitory computer readable storage media storing computer-executable instructions that, when executed by one or more processors of an electronic apparatus, cause the electronic apparatus to perform operations, the operations comprising:
controlling a power supply circuit based on a first target power corresponding to an operation step input by a user; and
controlling, based on a difference between a first input power of the power supply circuit and the first target power being greater than or equal to a predetermined value, the power supply circuit based on a second target power corresponding to the first input power of the power supply circuit.

20. The one or more non-transitory computer-readable storage media of claim 19, the operations further comprising:
increasing an input power of the power supply circuit to first input electric power; and
identifying, based on a predetermined condition being satisfied, whether the difference between the first input power and the first target power is greater than or equal to the predetermined value.
